(19) United States
(12) Patent Application Publication
(10) Pub. No.: US 2012/0197793 A1
(43) Pub. Date: Aug. 2, 2012

(54) DEPENDENT NOTIFICATION ALERT

(75) Inventors: David M. Grigg, Rock Hill, SC (US); Susan Smith Thomas, Gastonia, NC (US)

(73) Assignee: BANK OF AMERICA CORPORATION, Charlotte, NC (US)

(21) Appl. No.: 13/018,220

(22) Filed: Jan. 31, 2011

(51) Int. Cl. G06Q 40/00

(52) U.S. Cl. 705/41; 705/44

(57) ABSTRACT

Embodiments of the invention allow a primary user to add dependent users to one or more accounts (e.g., shared accounts) of the primary user, in order to control and monitor the transactions made by a dependent user who is authorized to make purchases using the user computer systems that are linked to the primary user's shared account. The shared account can be a credit account, a debit account, a credit line account, a pre-paid account, or any other type of account that can be used to pay for products. In other embodiments of the invention the primary user may be linked to the dependent user account, be it a shared account or the dependent user's own account, in order to receive notification alerts regarding the transactions that the dependent user is trying to make.

### FIELD

This invention relates generally to the field of dependent accounts, and more particularly embodiments of the invention relate to apparatuses and methods for providing alerts when dependent users are making transactions with an account.

### BACKGROUND

The Credit Card Accountability Responsibility and Disclosure Act of 2009 (Credit Card Act of 2009) is a federal law passed by the United States Congress and signed by the President on May 22, 2009. Congress describes the Credit Card Act of 2009 as comprehensive credit card reform legislation for establishing fair and transparent practices relating to the extension of credit. The Credit Card Act of 2009, among many other various impacts, limits access to cards for people of certain ages, and allows cardholders to set limits on credit cards. The Credit Card Act of 2009 makes it more difficult for people with poor or no credit history to obtain a credit card. Notwithstanding the Credit Card Act of 2009, in times of economic recession or depression, it may also be increasingly difficult for people with poor or no credit history to be approved for a credit card because some financial institutions become more risk adverse during these times, and thus may limit the amount of credit that they extend to users. Furthermore, credit card users are typically averse to acting as co-signers for people with poor or no credit history because they do not want to be liable for any debt that other people on the card might accrue. Additionally, families or business may want the ability to limit and view the transactions that other members of the family or employees within the business can make. Moreover, when a person making a transaction is denied for insufficient funds the person may not have the available cash to make necessary purchases. Thus, the person may not be able to pay for goods and services (herinafter “products”) until he can pay off a balance on the account, get money transferred from another account he owns, get an employer, friend, or family member to transfer money to his account, etc. In these cases the person may not have immediate access secondary funds that can be used in lieu of the denied account.

Thus, there is a need to develop apparatuses and methods that help businesses provide credit options to consumers who are restricted by the Credit Card Act of 2009, consumers with poor or no credit history, and/or consumers who want to control the spending habits of family members or employees, as well as helping users limit the debt that any consumers authorized to use the credit card account of the users can accrue.

### BRIEF SUMMARY

Embodiments of the present invention address the above needs and/or achieve other advantages by providing apparatuses (e.g., a system, computer program product, and/or other device) and methods for shared account systems, which allow multiple users to be linked through one or more accounts and use shared payment systems, such as shared mobile wallets to make purchases within the limits set for each user. In some embodiments of the invention there are one or more primary users that can set limits in the shared account systems to control the purchases that dependent users are allowed to make. Notifications of the spending habits of the dependent users can be sent to the primary user in order to allow the primary user to track, deny, and allow purchases of the dependent user.

Embodiments of the invention allow a primary user to add dependent users to one or more accounts (e.g., shared accounts) of the primary user, in order to control and monitor the transactions made by a dependent user who is authorized to make purchases using the user computer systems that are linked to the primary user's shared account. The shared account can be a credit account, a debit account, a credit line account, a pre-paid account, or any other type of account that can be used to pay for products. In other embodiments of the invention the primary user may be linked to the dependent user account, be it a shared account or the dependent user's own account, in order to receive notification alerts regarding the transactions that the dependent user is trying to make.

In some embodiments, the primary user can set the maximum limit that the dependent user can spend on the payment device up to the maximum amount that the financial institution has approved for the account. In some embodiments, the primary user can also limit the transactions that the dependent user can make at a store (i.e. a physical store location, over the Internet, over the telephone with a representative, etc.) for products. In some embodiments the store includes specific stores, such as, but not limited to chain stores or individual stores, or in other embodiments the store includes types of stores that are grouped together in various categories. A store can be grouped in more than one category, for example a one stop store that sells a range of products can be grouped as both a grocery store and an electronics store. In some embodiments the product includes specific products or lines of products, such as, but not limited to a product sold by a particular merchant, or in other embodiments products includes types of products that are grouped together in various categories. A product can be grouped into more than one category, for example, a specific beer can be grouped into a category with other beers and also be grouped into an alcoholic beverages category that includes beer, wine, and liquor.

The primary user can limit the transactions that the dependent user can make by, for example, adding Merchant Category Codes (MCCs), store names, store types, Universal Product Codes (UPCs), Stock Keeping Unit, product names, product types, and/or like identifiers to a blocked list or an approved list of stores or products. In some embodiments, the primary user can set both monetary limits and time limits on the transactions the dependent user can make at the blocked/approved types of stores or on the blocked/approved products that the primary user added to the blocked/approved list. Furthermore, the primary user can periodically edit the stores or the products on the blocked/approved list, as well as the monetary and time limits on the stores or products in order to control the transactions made by the dependent user as the needs of the dependent user change. In some embodiments, both the primary user and dependent user can view the transactions made through the account by logging into an online banking account. The dependent user is prevented from having the ability to access the sections of the dependent credit account related to the limits set by the primary user, which control the transactions the dependent user is allowed to make.

In some embodiments, as explained herein the payment device is described as a credit card. However, it is to be understood that the payment device can be another type of credit device, which can be scanned, transmit a wireless signal, entered manually into a system, etc. in order to make payments using the payment device, as will be described in further detail later. For example, in some embodiments of the invention the dependent credit card may not be a card at all, it may be a mobile device, such as a smartphone or personal digital assistant (“PDA”) or other electronic device that allows the dependent user to make a purchase at a store or over the internet by transmitting through a wire or wireless connection between the electronic device and the systems used to make the transaction.

In some embodiments of the invention, as explained in further detail later, the primary user can set notification alerts on the use of a dependent user account. The notification alerts can be set so the primary user can track different types of transactions made by one or more dependent users. In this way the primary user can track when a dependent user is getting close to reaching the transaction limits, and if necessary can take the appropriate action to change some of the transactions limits to allow the dependent user to make additional transactions. Changing the transaction limits can include, but is not limited to, increasing the monetary limits, transferring funds to the dependent account, allowing access to primary user accounts, increasing date limits on the transactions, etc. In some embodiments, the primary user can place approval alerts on the transaction limits or the notification limits in order to be notified of transactions that the dependent user is making so that the primary user has the power to approve or deny the transactions.

Embodiments of the present invention relate to systems, methods, and computer program products for receiving transaction information from a merchant system related to a transaction being made using an account, wherein the information is received by the merchant system from a dependent user through a dependent user system; determining if the transaction does or does not satisfy a preference set on a dependent account; and sending a denied notification alert to a primary user through a primary user system when the transaction does not satisfy the preference.

In further accord with an embodiment of the invention, the invention further comprises receiving an approval notification from the primary user to allow the transaction.

In another embodiment of the invention, the invention further comprises receiving a request from the primary user to change the preference in order to allow the transaction.

In yet another embodiment of the invention, the invention further comprises sending an allowance notification to the merchant system to allow the transaction.

In still another embodiment of the invention, the invention further comprises sending an accepted notification to a primary user through the primary user system when the transaction does satisfy the preference.

In further accord with an embodiment of the invention, the invention further comprises receiving a request from a primary user through the primary user system to add the dependent user to the shared account.

In another embodiment of the invention, the invention further comprises receiving a request from a primary user through the primary user system to set a preference on the use of a shared account by a dependent user.

In yet another embodiment of the invention, the preference is a prevention limit on the transaction that limits the transaction made by the dependent user based on a monetary limit, product limit, store limit, or time period limit.

In still another embodiment of the invention, the preference is an allowance limit on the transaction that limits the transaction made by the dependent user based on a monetary limit, product limit, store limit, or time period limit.

In further accord with an embodiment of the invention, the preference is a notification alert limit on the transaction made by the dependent user based on a monetary limit, product limit, store limit, or time period limit.

In another embodiment of the invention, the preference is a store preference and is assigned using a merchant category code, a store type, or a store name.

In yet another embodiment of the invention, the preference is a product preference and is assigned using a universal product code, a stock keeping unit, a product type, or a product name.

In still another embodiments of the invention, the primary user system is a shared mobile wallet. In further accord with an embodiment of the invention, the dependent user system is a shared mobile wallet. In another embodiment of the invention, the account is a credit card account, the account is a debit card account, or the account is a gift card account. In yet another embodiment of the invention, the gift card account is a prepaid account funded by an account owned by the primary user.

The features, functions, and advantages that have been discussed may be achieved independently in various embodiments of the present invention or may be combined in yet other embodiments, further details of which can be seen with reference to the following description and drawings.

### BRIEF DESCRIPTION OF THE SEVERAL VIEWS OF THE DRAWINGS

Having thus described embodiments of the invention in general terms, reference will now be made to the accompanying drawings, wherein:

FIG. 1 provides a high level process flow illustrating a transaction notification process, in accordance with one embodiment of the present invention;

FIG. 2 provides a transaction notification system environment, in accordance with one embodiment of the present invention;

FIG. 3 provides a process map illustrating a shared account step-up process, in accordance with one embodiment of the present invention;

FIG. 4 provides a process map illustrating a shared payment process, in accordance with one embodiment of the present invention;

FIG. 5 provides an online banking interface for setting up a shared account, in accordance with one embodiment of the present invention;

FIG. 6 provides a shared account interface, in accordance with one embodiment of the present invention;

FIG. 7 provides a shared preferences interface, in accordance with one embodiment of the present invention;

FIG. 8 provides a shared transactions interface, in accordance with one embodiment of the present invention;

FIG. 9 provides a shared mobile wallet interface for accessing various interfaces and setting preferences through the shared mobile wallet system, in accordance with one embodiment of the present invention;

FIG. 10 provides a process map illustrating a notification alert set-up process, in accordance with one embodiment of the present invention;

FIG. 11 provides a process map illustrating a notification alert process, in accordance with one embodiment of the present invention; and

FIG. 12 provides a transaction notification interface, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Although some embodiments of the invention described herein are generally described as involving a “bank,” one of ordinary skill in the art will appreciate that other embodiments of the invention may involve other businesses or financial institutions that take the place of or work in conjunction with the bank to perform one or more of the processes or steps described herein as being performed by a bank. Still in other embodiments of the invention the bank or financial institution described herein may be replaced with other types of businesses that offer shared payment systems to users.

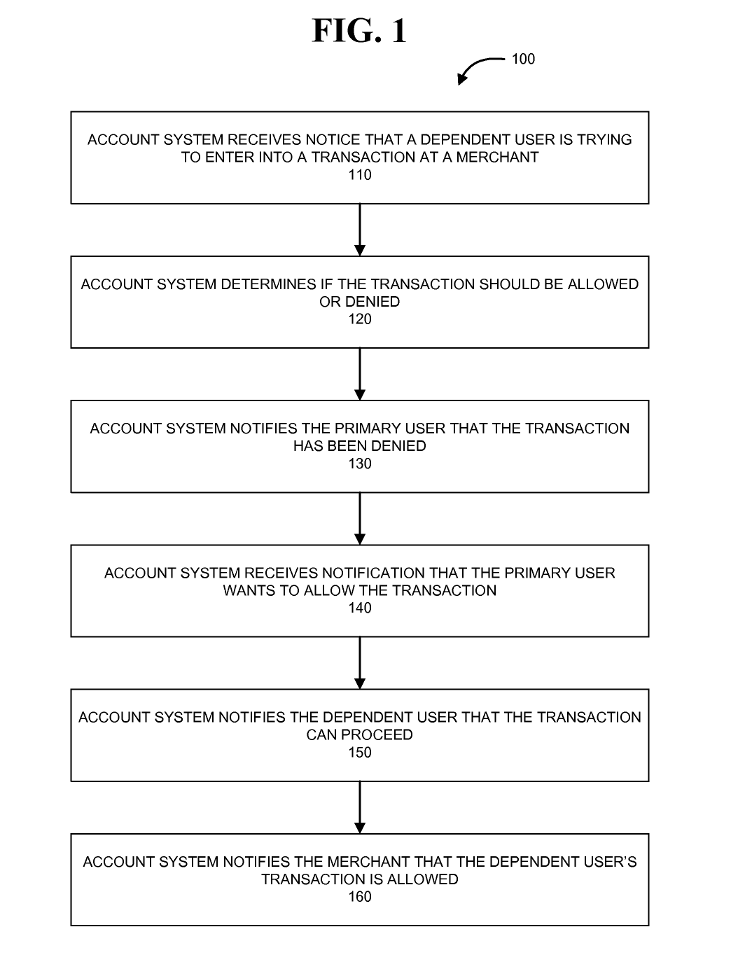

FIG. 1 illustrates a high level process flow for a transaction notification process 100, which will be discussed in further detail later. The first step in the transaction notification process is that the account system 10 receives a notice that a dependent user is trying to make a transaction at a merchant, as illustrated by block 110. The next step in the process is that the account system 10 determines if the transaction should be allowed or denied, as illustrated by block 120. If the transaction is denied, as illustrated by block 130, the account system 10 notifies the primary user 5 that the dependent user's transaction has been denied. Thereafter, if the primary user 5 wants to allow the transaction to take place, the account system 10 receives notification that the primary user 5 wants to allow the transaction, as illustrated by block 140. The account system 10 then notifies the dependent user 4 that the transaction can proceed, as illustrated by block 150. Thereafter, the account system 10 notifies the merchant that the dependent user's transaction is allowed, as illustrated by block 160.

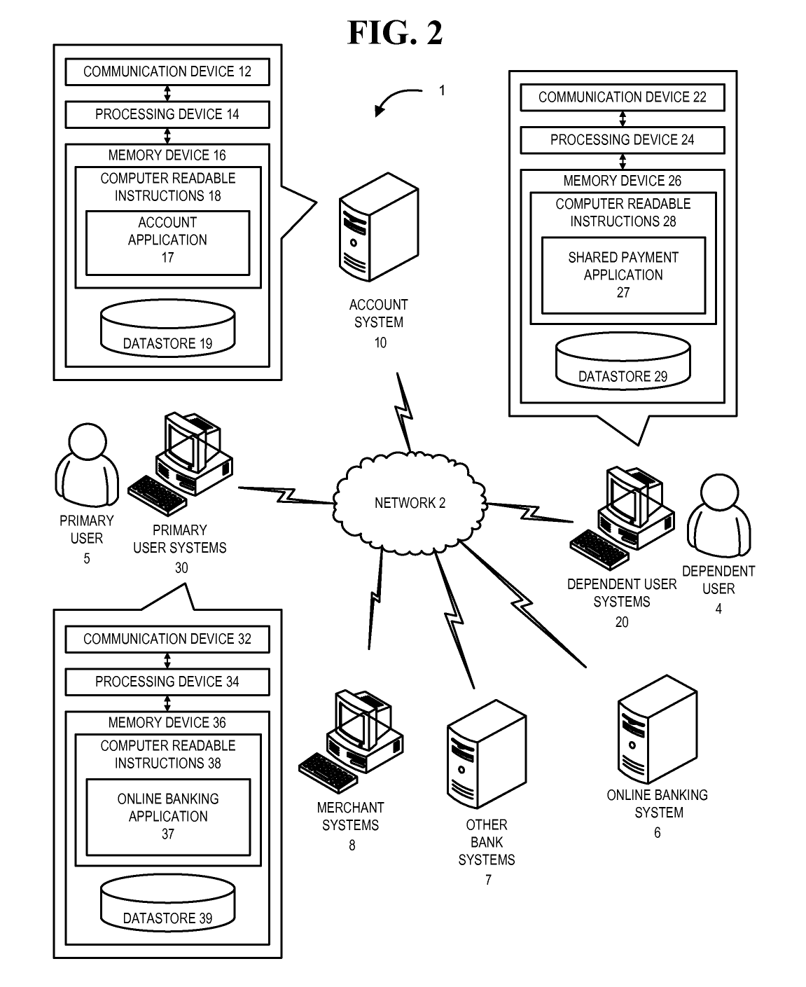

FIG. 2 illustrates a transaction notification system and environment 1, in accordance with an embodiment of the present invention. As illustrated in FIG. 2, the account system 10 is operatively coupled, via a network 2 to the dependent user systems 20, the primary user systems 30, online banking system 6, other bank systems 7, and/or merchant systems 8. In this way, the account system 10 can receive and send information from and to the dependent user systems 20, primary users systems 30, online banking system 6, other bank systems 7, and/or merchant systems 8, to track, send notification alerts, allow, and/or deny the purchases made by a dependent user 4. FIG. 2 illustrates only one example of embodiments of a transaction notification system environment 1, and it will be appreciated that in other embodiments one or more of the servers or systems may be combined into a single server or system or be made up of multiple servers or systems.

The network 2 may be a global area network (GAN), such as the Internet, a wide area network (WAN), a local area network (LAN), or any other type of network or combination of networks. The network 2 may provide for wireline, wireless, or a combination of wireline and wireless communication between devices on the network.

In some embodiments of the invention, the primary users 5 are primary account holders of a shared account and the dependent users 4 are users that the primary user 5 has allowed to use the shared account. In the shared account embodiments, the primary users 5 can set limits on the shared accounts, and are ultimately responsible for the debt accrued through the use of the shared accounts. The primary users, in some cases, are the only users that can set-up the shared account and control the preferences on the shared account for the dependent users 4, as explained in further detail later. The dependent users 4 are generally users that the primary users 5 want to have control over in regard to the dependent user's spending habits. The dependent users 4 may not be able to receive credit under the current laws governing credit cards or cannot by themselves receive approval from a financial institution for credit; the dependent user 4 may have joint control over the account (i.e., listed as a joint account holder), but may also have purchasing limits placed on them; the dependent users 4 may be employees of the primary user; the dependent users 4 may be any person that the primary user 5 wants to extend a gift to or make a payment to; etc. In some embodiments, a dependent user 4 is the legal dependent of the primary user 5, while in other embodiments a dependent user 4 is any person that is allowed to make purchases using funds attributable to or that come from the primary user's account or accounts.

In some embodiments the primary user 5 is a parent and the dependent user 4 is the child of the parent. The child may not be able to receive credit because the child is too young under the Credit Card Act of 2009 or other law, or the child has poor or no credit history and thus a financial institution may not approve the child for a credit card on the child's own. In some cases the child may be a student or may be living away from the parent, and may have a need to make purchases that he may not have the funds to make. Often a parent would want the child to have a credit card to make the necessary purchases the child needs or for emergency situations, school supplies, food, etc. Notwithstanding the child's need for credit or other sources of money, the parent would want to prevent the child from being able to abuse the credit card by preventing the child from being able to make purchases that the parent deemed unnecessary. The shared account may also allow the dependent user 4 to build up some credit history allowing the child to have a better chance to receive credit on his own when he reaches the proper age or has acquired the necessary credit worthiness.

In some embodiments, the primary user 5 does not have to be a parent of the dependent user 4. The primary user 5 can be a person that qualifies for credit from a financial institution, and the dependent user 4 can be a person that cannot qualify for credit on his own accord. For example, a child may need to control the spending of an elderly parent, a guardian may need to control the spending of a dependent, a person may need to control the spending of a friend or relative that cannot receive credit, an employer may need to control the spending of an employee, etc. In other embodiments of the invention, the primary user 5 and/or the dependent user 4 need not be actual people. In some embodiments of the invention, the primary user 5 can be a business or other entity, such as but not limited to a charitable organization, small business, fraternity, sorority, or other organization and the dependent user 4 is another entity or person who can act as a officer, agent, member, partner, employee, contractor, etc. of the primary user 5. In some embodiments the primary user 5 is additionally liable for the credit used by the dependent user 4, while in other embodiments the primary user 5 merely controls the dependent user's access to the credit without being additionally liable for the credit used.

In other embodiments of the invention, there does not have to be a shared account in order for the primary user 5 to receive notification alerts from transactions made by the dependent user 4. In these embodiments, the primary user 5 has an account and the dependent user 4 has a separate account. The primary user account and dependent user account can be linked such that the primary user 5 is notified of the transactions made by the dependent user 4. Moreover, the primary user 5 can allow the dependent user 4 access to funds in the primary user's accounts, can transfer funds to the dependent user account, and/or can provide other monetary support to the dependent user 4 in order to allow the dependent user 4 to make a transaction.

As illustrated in FIG. 2, the account system 10 generally comprises a communication device 12, a processing device 14, and a memory device 16. As used herein, the term “processing device” generally includes circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 14 is operatively coupled to the communication device 12 and the memory device 16. The processing device 14 uses the communication device 12 to communicate with the network 2 and other devices on the network 2, such as, but not limited to, the dependent user systems 20, primary user systems 30, online banking system 6, other bank systems 7, and/or merchant systems 8. As such, the communication device 12 generally comprises a modem, server, or other device for communicating with other devices on the network 2.

As further illustrated in FIG. 2, the account system 10 comprises computer-readable instructions 18 stored in the memory device 16, which in one embodiment includes the computer-readable instructions 18 of an account application 17. In some embodiments, the memory device 16 includes a datastore 19 for storing data related to the account system 10, including but not limited to data created and/or used by the account application 17.

In the embodiment illustrated in FIG. 2 and described throughout much of this specification, the account application 17 allows for a primary user 5 to be linked to a dependent user 4 using the primary user system 20, dependent user system 30, and/or online banking system. For example, in one embodiment the account application 17 allows the dependent application 27 to communicate with the primary application 37 to send, receive, and store information related to transactions, account preferences, and/or notification alerts, for the primary user 5 and dependent user 4.

The account application 17 stores the preferences that are established by the primary users. As used herein, “preferences” may be established by specifying restrictions or approvals of use by the dependent users 4, and/or notification alerts on the transactions made by the dependent user 4. In the case of a shared account system, the default may be unlimited use by the dependent user 4 except for noted restrictions established by the primary user 5, no permitted use by the dependent user except for permitted use explicitly defined by approvals established by the primary user 5, or a combination of restrictions and approvals. In the case of separate accounts that are linked with notification alerts, in some embodiments the primary user 5 can set notification alerts on the dependent user 4 account through the use of the account application 17. In other embodiments of the invention the dependent user 4 can request notification alerts be sent to a primary user 5 through the use of the account application 17. In either case the primary user 5 can be kept aware of the transactions being made by the dependent user 4.

In one embodiment, explained in further detail below, preferences or notification alerts can be set through the use of account limits, store limits, and/or product limits using store and/or product identifiers. For example, MCCs or other identifiers can be assigned to types of businesses, such as liquor stores, gambling establishments, clothing stores, restaurants, etc. or they can be assigned to specific stores within the types of stores. In some embodiments the MCCs for a specific store or type of store are assigned to each of the merchant systems 8, such as wireless information devices, card scanners, etc. for the store. In some embodiments MCCs, UPCs, or other identifiers are assigned to products. Therefore, when the dependent user 4 uses the dependent user systems 20 as a payment device through merchant system 8 at a store to purchase a product, the merchant system 8, and/or the shared payment system 20 sends the identifier (i.e., MCC, etc.) related to the store and/or the identifier (i.e., MCC, UPC) related to the product to the shared account application 17. The shared account application 17 checks the MCCs, UPCs, and/or other identifiers against the list of blocked/approved MCCs, UPCs, and/or other identifiers and denies the purchase if the purchase violates a preference imposed by the primary user 5.

In some embodiments preferences can be placed on certain stores, restaurants, websites, etc. and/or products that the primary user wants to block/approve, without using the MCCs, UPCs, and/or other identifiers. For example, the name of the particular business, the website address, uniform resource locator (“URL”), other business or website identifier may be added to the blocked/approved list associated with the shared account, so that when a user tries to make a purchase using the shared account at the blocked/approved store the transaction is denied/accepted as the case may be. The shared account application 17, allows the primary user to control the types and amounts of purchases that the dependent user can make with the shared account.

As further illustrated in FIG. 2, the dependent user systems 20 generally comprise a communication device 22, a processing device 24, and a memory device 26. The processing device 24 is operatively coupled to the communication device 22 and the memory device 26. The processing device 24 uses the communication device 22 to communicate with the network 2, and other devices on the network 2, such as, but not limited to, the account system 10, the primary user systems 30, online banking system 6, other bank systems 7, and/or merchant systems 8. As such, the communication device 22 generally comprises a modem, server, or other device(s) for communicating with other devices on the network 2 and a display, camera, keypad, mouse, keyboard, microphone, and/or speakers for communicating with one or more dependent users 4 or other users. In some embodiments of the invention the communication device 22 may include or work in conjunction with a payment device that is integral to the communication device 22 or an add on feature to the dependent user systems 20. The communication device 22 and/or payment device may include specific hardware/software that allows the dependent user system 20 (i.e. smartphone, PDA, etc.) to communicate secure payment information to and from the merchant systems 8 or other systems with which the dependent user systems 20 communicate. The communication device 22 may also comprise or work in conjunction with a display, camera, keypad, mouse, keyboard, microphone, and/or speakers for communicating with one or more dependent users 4.

The dependent user systems 20 could be a computer system, laptop, personal digital assistant (“PDA”), phone, smartphone, digital payment card, payment card with information embedded therein, or other payment device. As illustrated in FIG. 2, the dependent user systems 20 comprise computer-readable program instructions 28 stored in the memory device 26, which in one embodiment includes the computer-readable instructions 28 of a dependent application 27. In some embodiments, the memory device 26 includes a datastore 29 for storing data related to the dependent user systems 20, including but not limited to data created and/or used by the dependent application 27.

The dependent application 27 allows the dependent users 4 to view preferences set by the primary users 5, notify the primary users 5 of transaction information, and/or allows the dependent users 4 to request approval of a transaction to the primary user systems 30 directly, or through the use of the online banking systems 6 and/or the account systems 10.

The dependent application 27 allows the dependent users 4 to view preferences the primary user 5 set by accessing the account application 17 directly through the dependent user systems 20 or by accessing the online banking application on the online banking systems 7 through the dependent user systems 20. Furthermore, the dependent application 27 can be used to transmit information to merchant systems 8 and/or to the account system 10, online banking system 7, or other bank systems 6 directly or through the merchant systems 8. The dependent user systems 20 can be used to enter into transactions with a merchant using the dependent application 27. For example, the dependent user 4 may enter into a transaction by placing the dependent user system 20 (i.e. smartphone, PDA, or other like device) near the merchant systems 8 to allow the passage of information between the merchant systems 8 and the dependent user system 20. In another example, the user 4 may make purchases over the network 2 (i.e., Internet) utilizing a feature in the dependent application 27. Furthermore, the dependent application 27 may be used to send notification alerts to the primary user 5 in order to secure the funds necessary to make a transaction that the dependent user 5 is trying to make.

In some embodiments, dependent user systems 20, such as shared mobile wallet (i.e., smarphone or other system) could include a data capture device that is operatively coupled to the communication device 22, processing device 24, and the memory device 26. The data capture device could include devices such as, but not limited to, a scanner device, image capture device, wireless data capture device (i.e. radio frequency identification (“RFID”) device, global positioning satellite (“GPS”) device, etc.), which can be used by a dependent user 4 to capture information from products or stores. In some embodiments of the invention, wherein the dependent application 27 includes a data capture device, the memory device 26 may include computer readable instructions 28 of a data capture application, which either alone, through the dependent application 27, or through another application, communicates with the account application 17, online banking application, or other applications. The data capture application allows a dependent user to capture information about a product or store and check through the account application 17 and/or dependent application 27 if he is allowed to make a transaction at the store for the product.

As further illustrated in FIG. 2, the primary user systems 30 generally comprise a communication device 32, a processing device 34, and a memory device 36. The processing device 34 is operatively coupled to the communication device 32 and the memory device 36. The processing device 34 uses the communication device 32 to communicate with the network 2, and other devices on the network 2, such as, but not limited to, the account system 10, the dependent user systems 20, the online banking systems 6, the other bank systems 7, and/or the merchant systems 8. As such, the communication device 32 generally comprises a modem, server, or other devices for communicating with other devices on the network 2. In some embodiments of the invention the communication device 32 may include or work in conjunction with a payment device that is integral to the communication device 32 or an add on feature to the primary user systems 30. The communication device 32 and/or payment device may include specific hardware/software that allows the primary user system 20 (i.e. smartphone, PDA, etc.) to communicate secure payment information to and from the merchant systems 8 or other systems with which the primary user systems 30 communicate. The communication device 32 may also comprise or work in conjunction with a display, camera, keypad, mouse, keyboard, microphone, and/or speakers for communicating with one or more primary users 5.

The primary user systems 30 could be a computer system, laptop, PDA, phone, smartphone, digital payment card, payment card with information embedded therein, or other payment device. As illustrated in FIG. 2, the primary user systems 30 comprise computer-readable program instructions 38 stored in the memory device 36, which in one embodiment includes the computer-readable instructions 38 of a primary application 37. In some embodiments, the memory device 36 includes a datastore 39 for storing data related to the primary user systems 30, including but not limited to data created and/or used by the primary application 37.

The primary application 37 allows the primary user 5 to receive transaction notification alerts of transactions the dependent user 4 wants to make, access the account linked to the dependent user 4, edit preferences (i.e. change limit preferences, time preferences, add or remove dependent users, etc.), and/or check transactions made through the dependent user systems 20 directly through the primary application 37. In other embodiments, the primary user 5 can perform these functions indirectly through the account system 10, online banking system 6, or other bank systems 7. In some embodiments, any changes made to the account preferences directly through the primary application 37 are updated automatically in other applications, such as but not limited to the dependent account application 27, an online banking application, etc. In this way, in embodiments that relate to shared accounts the primary user 5 can receive notification alerts of transactions that the dependent user 4 is trying to make that have been denied, and either approve the transaction or edit the preferences to allow the transaction in the future. In the embodiments that relate to separate accounts that are linked the primary user 5 can receive notification alerts of transactions that the dependent user 4 is trying to make that have been denied, either transfer funds to the dependent user account, allow shared access to a primary user account, allow the transaction using funds from a primary user account, etc.

In some embodiments, the primary user systems 30, such as a shared mobile wallet (i.e., a smartphone, PDA, etc.), could include a data capture device that is operatively coupled to or integrated within the communication device 32, processing device 34, and the memory device 36. The data capture device could include devices such as, but not limited to, a scanner device, image capture device, wireless data capture device (i.e. radio frequency identification (“RFID”) device, GPS device, etc.), which can be used by a primary user 5 to capture information from a product or store, set preferences based on the information captured, allow and/or prevent transactions, and/or capture data to enter into a transaction as explained in further detail later.

In some embodiments of the invention, wherein the primary user system 30 includes a data capture device, the memory device 36 may include computer readable instructions 38 of a data capture application, which either alone, through the primary application 37, or through another application, communicates with the account application 17, online banking application, or other applications. The data capture application allows a primary user 5 to capture information about a product or store, and set limits on the product or store, which can be transferred to the account application 17 and/or primary application 27.

Once the preferences and notification alerts are set up by the primary user 5, in one embodiment of the invention, when a dependent user 4 makes a purchase at a merchant, the dependent user systems 20 communicate with primary user systems 30 directly, or through the use of the account systems 10 or other bank systems 7, to notify the primary user 5 of the transaction taking place. In other embodiments of the invention when the dependent user 4 makes a purchase at a merchant, the merchant system 8 communicates with the primary user system 30, directly or through the account system 10, the dependent user system 20, or other bank systems 7, to notify the primary user 5 of the transaction taking place. The account application 17 sends a notification alert to the primary user 5 depending on the preferences and notification alerts set up by the primary user 5. Thereafter, the account application 17 accepts or denies the purchase made by the dependent user 4 depending on the preferences that the primary user 5 has put on the dependent user's use of the account. In other embodiments the account application 17 sends an approval alert to the primary user 5 and accepts or denies the transaction made by the dependent user 4 based on the allowance or denial of the primary user 5 using the primary user systems 30. The account application 17 allows the primary users 5 and dependent users 4 to access their accounts in order to view any transactions that were processed or prevented.

The online banking systems 6 are operatively coupled to the account system 10, dependent user systems 20, primary user systems 30, other bank systems 7, and/or merchant systems 8 through the network 2. The online banking systems 6 have systems with devices the same or similar to the devices described for the account system 10, dependent user systems 20, and/or primary user systems 30 (i.e., communication device, processing device, memory device with computer-readable instructions, datastore, etc.). Thus, the online banking systems 6 communicate with the account system 10, dependent user systems 20, primary user systems 30, other bank systems 7, and/or merchant systems 8 in the same or similar way as previously described with respect to each system. The online banking systems 7, in some embodiments, are comprised of systems and devices that allow the primary users 5 and/or dependent users 4 to access account information, set preferences, receive notification alerts, and/or allow transactions through an online banking application.

The dependent users 4, in some embodiments, are allowed to access an online banking account through the online banking system 6 for viewing the preferences related to the shared account for the dependent user 4 or the transactions the dependent user 4 makes. However, the dependent user 4 will not typically have the ability to set or change the preferences related to them, which were set by the primary user 5. As such, the primary user 5 and dependent user 4 usually have different online banking accounts with different login identifiers.

The other bank systems 7 are operatively coupled to the account system 10, dependent user systems 20, primary user systems 30, online banking system 6, and/or merchant systems 8 through the network 2. The other bank systems 7 have systems with devices the same or similar to the devices described for the account system 10, dependent user systems 20, and/or primary user systems 30 (i.e., communication device, processing device, memory device with computer-readable instructions, datastore, etc.). Thus, the other bank systems 7 communicate with the account system 10, dependent user systems 20, primary user systems 30, online banking systems 6, and/or merchant systems 8 in the same or similar way as previously described with respect to each system. The other bank systems 7, in some embodiments, are comprised of systems and devices that store and access account information or other information within or outside of the bank.

The merchant systems 8 are operatively coupled to the account systems 10, dependent user systems 20, primary user systems 30, online banking system 6, and other bank systems 7 directly or indirectly through the dependent user systems 20 over the network 2. The merchant systems 8 have devices the same or similar to the devices described for the account system 10, dependent user systems 20, primary user systems 30, online banking system 6, and/or other bank systems 7 (i.e. communication device, processing device, memory device with computer-readable instructions, datastore, etc.). Thus, the merchant systems 8 communicate with the account systems 10, dependent user systems 20, primary user systems 30, online banking systems 6, and/or other bank systems 7, in the same or similar way as previously described with respect to each system.

The merchant systems 8 can be computer systems that incorporate scanners, manual input devices, or other data reading devices that can read and capture information embedded in credit cards or other payment devices through magnetic strips, radio frequency identification tags, other wireless transmitters, other scannable features, manually inputted information, etc. The information captured by the merchant systems 8 from the dependent user systems 20 and/or primary user systems 30 allows the merchant system 8 to charge the account of the primary user 5 or dependent user 4. For example, the merchant systems 8 can be registers located in a store, Internet websites that are accessed by the dependent user systems 20 and/or primary user systems 30 remotely, etc., which allow the primary user 5 and/or dependent user 4 to make purchases from the merchant. In one embodiment, information related to the transaction being made by the dependent user system 20 is captured at the store, or through the merchant website, and a notification is sent to the primary user 5 so the primary user 5 can allow, deny, release funds, and/or change preferences to allow or prevent the dependent user 4 from completing the transaction.

In one embodiment the dependent user system 20 is a shared mobile wallet embodied in a user's smartphone. The dependent user 4 makes a purchase using the smartphone on the merchant system 8. The smartphone captures information about the purchase that the user 4 is making and transfers that information to the account system 10. The account application 17 determines if the dependent user account can support the transaction, and/or if the transaction meets the preferences set by the primary user 5, and if it does allows the purchase to continue. If the dependent user account cannot support the transaction, and/or if the transaction does not meet the preferences set by the primary user 5 the transaction is denied. In this case the primary user 5 is sent a notification alert that the dependent user's transaction is denied. Thereafter, the primary user 5 can do nothing and allow the transaction to stay denied, or the primary user 5 can allow the transaction, edit the preferences so the transaction is allowed in the future, transfer funds to the dependent user account, allow the transaction to occur using funds from the primary user account, etc.

It is understood that the servers, systems, and devices described herein illustrate one embodiment of the invention. It is further understood that one or more of the servers, systems, and devices can be combined in other embodiments and still function in the same or similar way as the embodiments described herein.

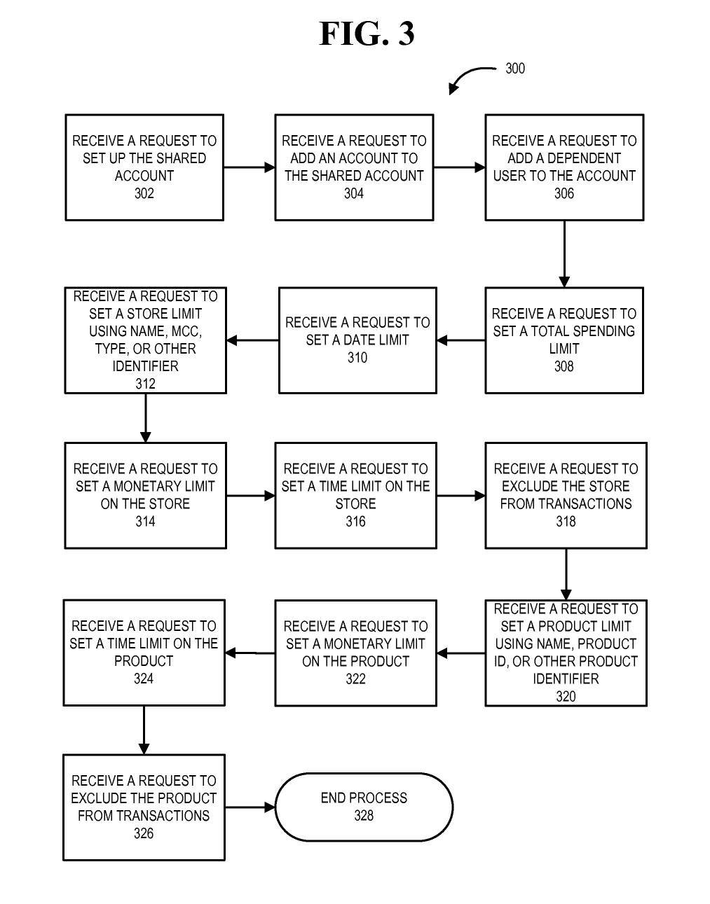

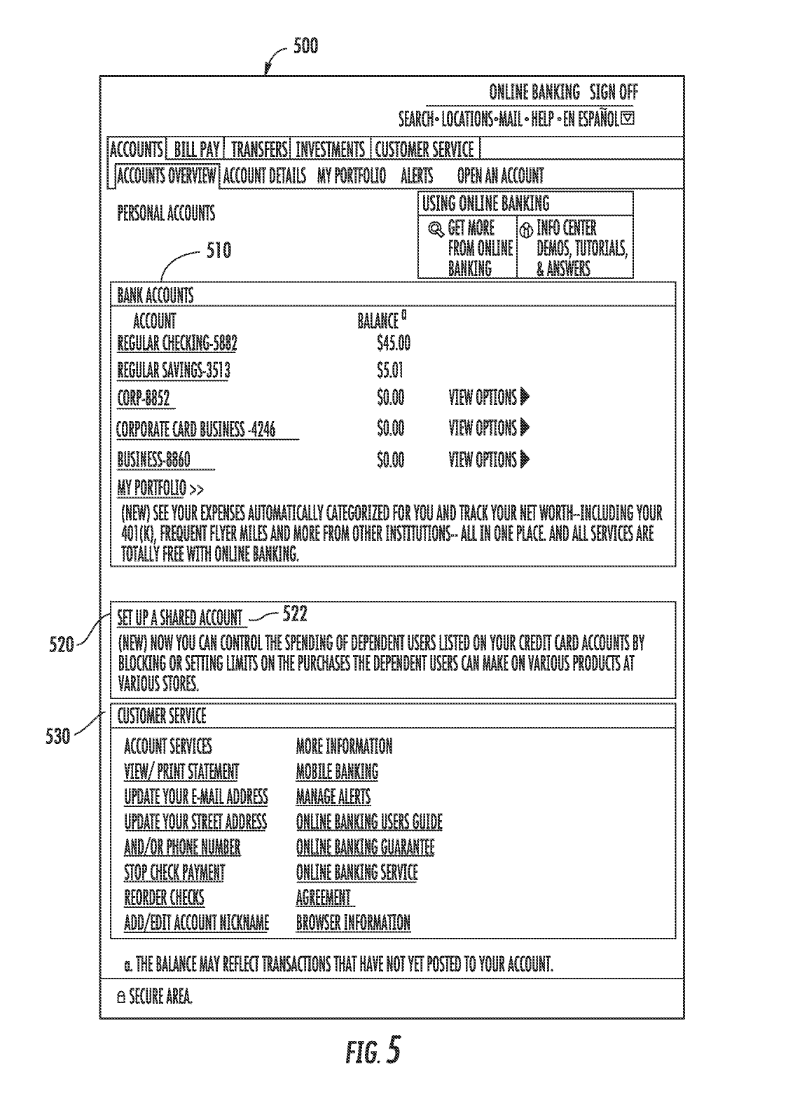

FIG. 3 illustrates a shared account step-up process 300, in accordance with an embodiment of the present invention wherein the primary user 5 and dependent user are linked through at least one shared account. Therefore, the primary user 5 is able to control the transactions the dependent user 4 can make through preferences that are set on the dependent user's use of the shared account. As illustrated in block 302 of FIG. 3, the account application 17 may receive a request from a user 4 to set up the shared account. For example, illustrated in FIG. 5 is an online banking interface 500 that summarizes a user's account with a bank. The online banking interface 500 comprises a bank accounts section 510, a shared account section 520, and a shared customer service section 530. The primary user 5 can navigate the bank accounts section 510 to review and analyze the accounts that the primary user 5 has with the bank. In some embodiments of the invention, if the primary user 5 has already set up the shared account tool, the bank accounts section 510 may have a link for the shared account. The shared account section 520 allows the primary user to select a shared account link 522 in order to enroll in the shared account tool. The customer service section 530 allows the primary user 5 to find, receive, and ask for help related to various topics within the bank.

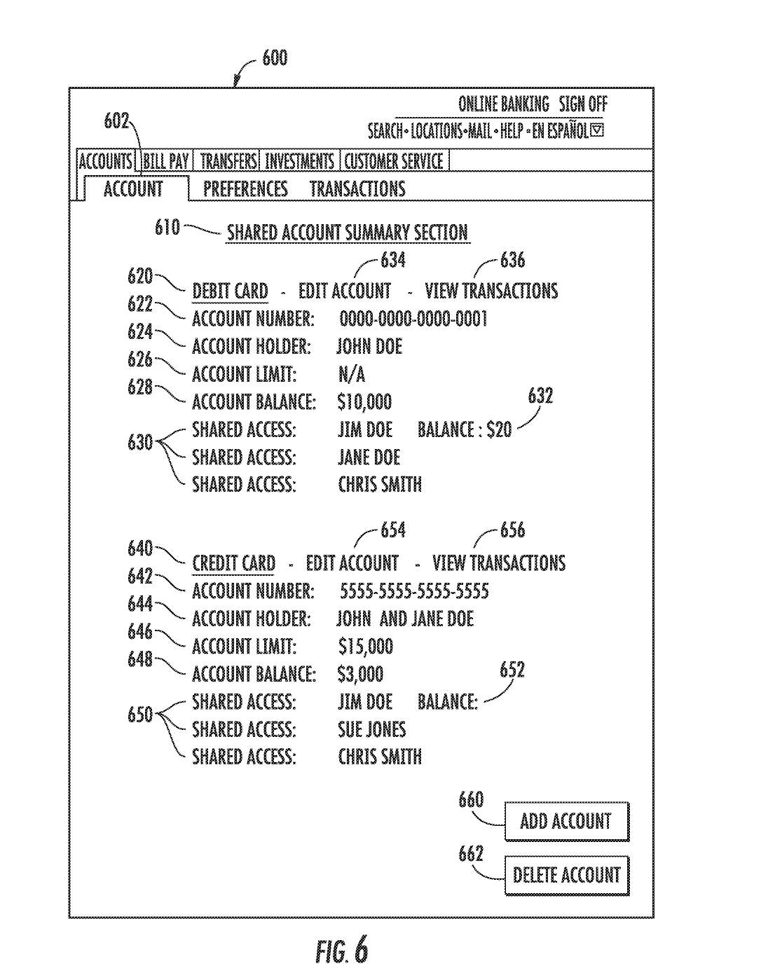

After selecting the shared account link 522 the primary user 5 is taken to the shared account interface 600 in the account tab 602, as illustrated by FIG. 6. If the primary user has already set up the shared account in the past then the shared account interface 600 may illustrate in the shared account summary section 610 the accounts that have been added to the shared account. For example, as illustrated in FIG. 6, the shared account summary section 610 shows that the primary user has added a debit card and a credit card to the shared account. The debit card section 620 illustrates the account number 622, the account holder 624, the account limit 626, the account balance 628, the shared access 630, and the shared balance 632 for one or more dependent users 4 that have been added to the shared account. There is also a debit card edit account link 634 and a debit card view transactions link 636. The debit card edit account link 634 allows the primary user to add or drop dependent users from having access to the shared debit card account, or edit the preferences for the dependent users that have access to the shared debit card account. The debit card view transactions link 636 allows the primary user the ability to view the transactions that the dependent users have made with respect to the shared debit card account. The credit card section 640 illustrates the same information as is illustrated and described for the debit card section 620.

As illustrated by block 304 in FIG. 3, the account application 17 receives a request to add an account to the shared account. For example, if the primary user 5 is setting up the shared account for the first time, in some embodiments, the shared account interface 600 may be blank. The primary user 5 may have to select the add account button 660 to add one of the primary user's accounts with the bank to the shared account interface. In other embodiments of the invention, the primary user 5 can select the add account button 660 to add another type of account to the shared account summary section 610. The additional accounts can be for example, an equity line of credit, an investment account, a prefunded account, a gift account, another credit card account, another debit card account, etc. In other embodiments of the invention, the primary user 5 can delete accounts by selecting the delete account button 662.

When the primary user 5 selects the edit account links 634 or 654 the primary user is taken to the preferences interface 700. In other embodiments of the invention when the primary user 5 selects the add account button 660 the primary user 5 also taken to the preferences interface 700 or to an add account interface that looks the same or similar to the preferences interface 700. The preferences interface has an account type section 710 and a preferences section 730.

In order to add an account to the shared account, in some embodiments, the primary user 5 can select an account 712 using a drop down menu. The list of accounts may include the types of accounts the primary user 5 holds with the bank and/or the list of accounts may include accounts that the primary user 5 does not hold with the bank but may sign up for, such as additional credit cards that the primary user 5 has not yet activated or gift accounts that the primary user 5 has not set up. The primary user 5 selects the account that the primary user 5 wants to add and selects the new button 714 to add the account to the shared accounts list, which is illustrated in the account interface 600. In other embodiments the primary user 5 can select an account that is already a part of the shared accounts list in order to edit the preferences of a specific shared account.

As illustrated in block 306 of FIG. 3, the account application 17 receives a request to add a dependent user 4 to the account. In the account type section 710 the primary user can enter a dependent user 4 in the shared access 714 area and select the new button 716 to add the dependent user 4 to the shared account. In some embodiments of the invention the dependent user 4 has an account at the bank, so the primary user 5 need only to ender the name of the dependent user 4 and select the user's name to add the user to the shared account. In some embodiments, additional information is displayed with the dependent user's name in order to identify the dependent user 4. In other embodiments, in order to add the dependent user 4 to the shared account the primary user 5 may need to enter the account number of the dependent user 4 using the shared access account number 718. In some embodiments of the invention the dependent user 4 may be a customer of another bank. In these embodiments the primary user 5 may need to enter other identification information other than the dependent user's name, such as the shared access account number 718 and/or the shared access account bank 720 that the dependent user 4 is a part of, or other identification information.

The preferences interface 700 also has a preferences section 730. The preferences section 730 allows the primary user 5 to set various limits on the shared account and/or the dependent user 4 assigned to the shared account. As illustrated in block 308 of FIG. 3 the account application 17 receives a request to set a total spending limit. The primary user 5 can enter the total spending limit 732 for the account and/or for the particular dependent user 4. In some embodiments the total spending limit 732 may be the total spending limit for the account for all of the dependent users 4 assigned to the account.

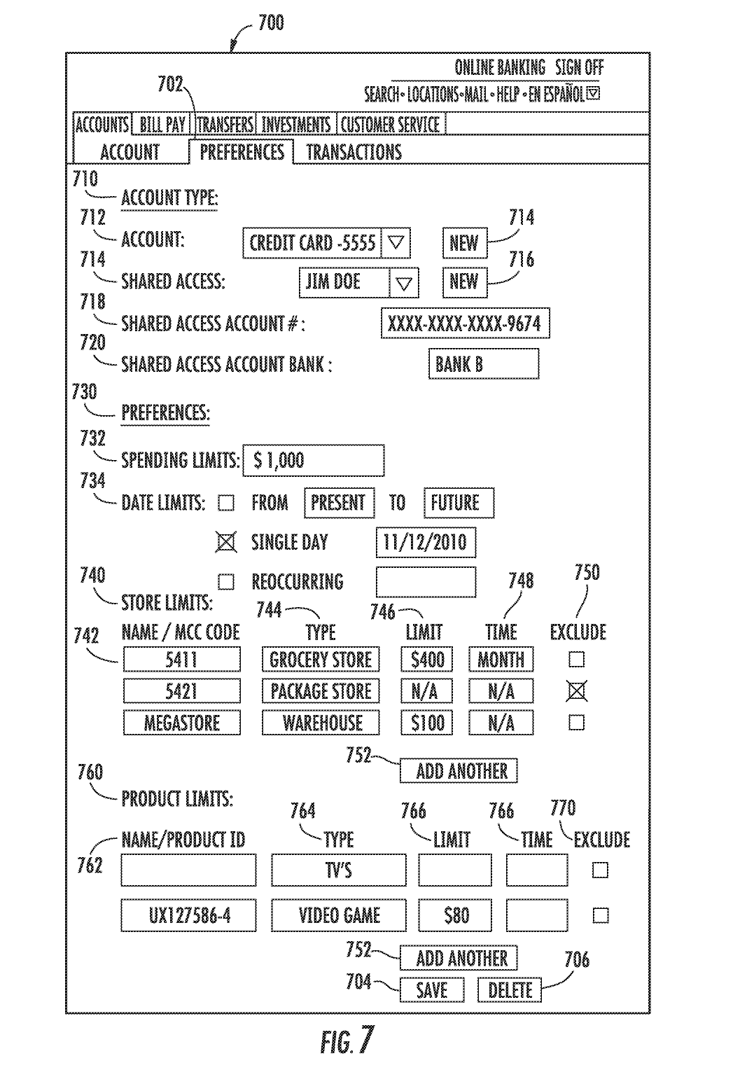

As illustrated by block 310 in FIG. 3, the account application 17 may also receive a request to set a date limit. The primary user 5 can enter a date range, single date, or recurring date that allows or prevents the dependent user 4 from making transactions with the shared account on various days, as illustrated in the date limit 734 in FIG. 7. In this way the primary user 5 can limit the dependent user's transactions to a specific day (i.e., the day of class registration to purchase books for school), a date range (i.e., only while the dependent user 4 is away for school), or a recurring day (i.e., first of the month, so that the dependent user 4 can pay for utilities each month).

Block 312 in FIG. 3 also illustrates that in some embodiments the account application 17 can also receive a request to add a store to the preferences interface 700 using a store name, MCC number, store type, or other store identifier. As illustrated by block 314 in FIG. 3, the account application 17, in some embodiments receives a request to set a monetary limit on the store. As illustrated by block 316, the account application 17, in some embodiments receives a request to set a date limit on the store. As illustrated by the store limits section 740 in FIG. 7, the primary user 5 can enter a name or MCC number in the name/MCC column 742, the store type in the store type column 744, a limit for the store or MCC number in the limit column 746, and/or a time period to make the transaction in the time column 748. In this way a primary user 5 can set a price or date limit on the a particular store, chain of stores, type of store, or industry (i.e. using the MCC number) in order monitor, control, and track the purchases of a dependent user 4.

In the case of MCCs, these numbers are industry standard codes assigned to types of stores, individual stores, or potentially in some cases actual products, in an effort to categorize the types of stores, stores, and/or products into various groups. Therefore, the primary user 5 can add different MCCs, such as, but not limited to MCCs for grocery stores, men's and women's clothing stores, electronic sales, eateries and restaurants, package stores (for beer, wine, and liquor), health and beauty shops, etc. to a blocked list of transactions that the primary user wants to regulate or block the dependent user 4 from making. In some embodiments of the invention, adding the MCCs to the blocked list completely prevents the dependent user from making purchases at the store or for a product. In other embodiments, as illustrated in FIG. 7, the primary user 5 can place a particular monetary limit on the amount of money the dependent user 4 can spend in a type of store, in a specific store, or on a product. In some embodiments, the primary user 5 can place time limits on the monetary limits for particular MCCs. For example, as illustrated in FIG. 7, the primary user 5 can add the MCC for grocery stores to the blocked list and set a monetary limit of five hundred (500) dollars on the grocery store, therefore preventing the dependent user from spending more than five hundred (500) dollars at a grocery store. Furthermore, as illustrated in FIG. 7, the primary user 5 can also set a time limit for the monetary limit, such as a time limit of one month, therefore, in this example, preventing the dependent user 4 from spending more than five hundred (500) dollars at a grocery store in a one month period. Example time periods include a single transaction, a predefined number of transactions, a day, a number of days, a month, a year, a number of years, etc.

In some embodiments of the invention the primary user 5 can put different limits on the same MCCs. For example, the primary user 5 can also set a limit of one hundred (100) dollars a day at a grocery store, therefore preventing the dependent user 4 from spending both more than one hundred (100) dollars a day and five hundred (500) a month at a grocery store.

If the primary user 5 does not want the dependent user 4 to be able to purchase anything related to a particular MCC, in one embodiment the primary user 5 can set a limit of zero (0) dollars for the particular MCC. For example, if the primary user 5 wants to prevent a dependent user 4 from purchasing any products at a package store, such as beer, wine, and liquor, the primary user 5 may set a limit of zero (0) dollars on the MCC related to package stores generally.

In other embodiments of the invention, the primary user 5 can add specific stores to the blocked list if the primary user 5 wants to limit the transactions the dependent user 4 can make. For example, the primary user 5 can prevent the dependent user 4 from purchasing anything from a particular pub. Furthermore, for example, the primary user 5 can set a limit of five hundred (500) dollars at the campus bookstore, which allows the dependent user 4 to purchase the necessary books for classes, but not other items at the campus bookstore.

In some embodiments, as illustrated in block 318 of FIG. 3, the account application 17 can receive a request to exclude a dependent user 4 from making a transaction at a store on the list. As illustrated in the preferences interface in FIG. 7, the exclude column 750 includes boxes that can be selected by the primary user 5 to exclude transactions at specific stores, types of stores, or industries (e.g., using the MCC numbers) by selecting or not selecting the exclude box in the exclude column 750.

In some embodiments of the invention the primary user 5 can add another store limit by selecting the add another button 752, as illustrated in the preferences interface 700.

In some embodiments, not illustrated in FIG. 7, the preferences interface 700 can include a list for approved transactions, and/or approved and blocked transactions in two separate lists. For example, the approved list allows the primary user 5 to limit the transactions the dependent user 4 can to make to only the stores or products on the approved list. The approved list works in much the same way as a blocked list, in that the primary user 5 can set limits on the stores and products, such as, but not limited to monetary and time limits by using MCCs, stores, products, or other identifiers. The difference between the blocked list and the approved list being that the dependent user 4 can make any type of transaction outside of any store or product on the blocked list, while the approved list only allows the dependent user 4 to make transactions that are included on the approved list.

As illustrated by block 320 in FIG. 3, the account application 17 receives a request to add a product to the preferences interface 700 using a product name, product identification number, or other product identifier. As illustrated by block 322 in FIG. 3 the account application 17 receives a request to add a monetary limit on a product. Furthermore, as illustrated by block 324 in FIG. 3 the shared account application 17 receives a request to add a time limit to a product. As illustrated by the product limits section 760 the primary user can enter a name or product ID in the name/product ID column 762, the product type in the product type column 764, a limit for the product or product type in the limit column 766, and/or a time period to make the transactions in the time column 768. In this way a primary user 5 can set a price or date limit on the a particular product, type of product, product line, etc. in order monitor, control, and track the purchases of a dependent user.

Block 326 of FIG. 3 illustrates that the account application 17 can receive a request to exclude the dependent user 4 from making transactions on a specific product. As illustrated in the preferences interface 700 in FIG. 7, the exclude column 770 includes boxes that can be selected by the primary user 5 to allow or exclude transactions on specific products, types of products, product lines, etc. by selecting or not selecting the exclude box in the exclude column 770.

The product limits are added to the preferences interface 700 in the same or similar way as previously discussed above regarding the limits on stores. That is the preferences interface 700 can include separate lists for approved product transactions and blocked product transactions that have associated monetary limits, date limits, etc.

In some embodiments of the invention UPCs relating to specific products or types of products, or other product identifiers, such as Stock Keeping Units, etc., can be used in addition to or instead of MCCs, product names, or other identifiers. For example, UPCs are codes that are assigned to each product in the market. The UPCs have a bar code assigned to each UPC so when the product is purchased computer systems identify the product for purposes such as pricing, accounting, inventory, etc. Products can be added to the blocked/approved list in the preferences interface 700 using a UPC, product name, or other identifier in the name/product ID 762 area.

In some embodiments of the invention the primary user 5 can add another product limit by selecting the add another button 772, as illustrated in the preferences interface 700. Furthermore, the primary user 5 can save any changes made in the preference interface 700 by selecting the save button 704 and delete any limits using the delete button 706.

The primary user 5 can at any time log into the online banking application or use the primary application 37 to edit the limits set on the shared account. For example, if the primary user 5 originally set a limit of five hundred (500) dollars at the campus bookstore so the dependent user 4 could buy books for classes, the primary user 5 can change the limit to zero (0) dollars after the dependent user 4 has purchased the books, in order to prevent the dependent user 4 from making additional transactions at the campus bookstore for other products, such as clothing or other supplies. In some embodiments of the invention, when the primary user 5 first sets up the limits on the shared account and/or at any point thereafter when the primary user 5 changes the limits on the shared account a notification can be sent to the dependent user 4 identifying the limits that were set or changed by the primary user. In some embodiments the dependent user 4 can be notified of any limits set or changed by the primary user 5 through text message, e-mail, telephone call, or any other communication channel.

In still other embodiments of the invention other identifiers can be used in place of or in conjunction with MCCs, UPCs, or other identifiers. For example 2D barcodes, Quick Response codes (“QD codes”), RFID tags, etc. that are assigned to products could be added to a blocked/approved list of products in the shared account. Therefore, products that the dependent user 4 tries to purchase, which use these identifiers would be checked by the account application 17 against the blocked/approved list before the transaction could be approved.

In one embodiment of the invention, in order to add the MCCs, stores, or products to the blocked/approved list the primary user 5 may enter the MCC, type of store, store name, address, etc. into a search feature and thereafter add each into the blocked/approved list after they are found through the search feature. For example, the primary user may enter the name of a store, the address of the store, the MCC, and/or the type of store into a search feature to identify the store or MCC based on the search criteria inputted. When the correct store or MCC is identified the primary user 5 may add the store or MCC to the blocked/approved list. Thereafter, the primary user 5 may set the monetary limits and time limits for each MCC, store, or product as previously described. In other embodiments of the invention, the blocked/approved lists or the search feature includes drop-down features or browsing lists that contain the store name, store types, store identifiers, product names, products types, and/or product identifiers that allow a primary user 5 to identify the stores or products that the primary user 5 wants to add to the blocked/approved lists.

In some embodiments of the invention the primary user 5 may add a range of MCCs to the blocked list so that the dependent user does not need to add every individual MCC related to a particular industry to the blocked/approved list. For example, the primary user 5 may add the group of MCCs from three-thousand (3000) to three-thousand two-hundred and ninety-nine (3299) which covers “Airlines” in order to limit the transactions the dependent user 4 can make with all merchants related to airlines.

In some embodiments of the invention, the primary user 5 may set an overall credit limit for a period of time, such as but not limited to per day, number of days, week, number of weeks, months, number of months, year, etc. The primary user 5 may then limit stores or products based on type of store, store, type of product, product, MCC, UPC, and/or other identifier as a percentage of the overall credit limit for a specific period of time. For example, the credit limit on a bookstore may be set by the primary user 5 at five-hundred (500) dollars. Thereafter, the primary user 5 can set a limit that the dependent user 4 can spend one-hundred (100) percent of the credit limit in September, fifty (50) percent of the credit limit in October, and zero (0) percent the rest of the year.

In some embodiments of the invention the preferences interface 700 can be populated by the primary user 5 using drag and drop features in order to set the limits on the total credit as well as the stores and products in the blocked/approved lists in the shared account.

In the embodiments where there is more than one dependent user 4 under the shared account, each dependent user 4 may have their own preference interface 700 and transaction interface 800. The separate interfaces for each dependent user 4 allows the primary user 5 to better manage each account because the primary user 5 can set limits and view the transaction history of each dependent user 4 individually based on the needs of each individual dependent user 4.

In some embodiments of the invention, instead of creating transaction limits that either block/approve transactions made by dependent users 4, other limits can be applied to stores or products that serve simply as notification limits instead of denial/acceptance limits. Therefore, in some embodiments, the primary user 5 allows the dependent user 4 to make various types of transactions at stores or for products, but sets notification limits in order to be notified when the dependent user 4 makes the transactions. In these embodiments, the primary user 5 can track the transactions made by the dependent user 4 regardless of whether or not the primary user 5 has set preference limits on the types of transactions made by the dependent user 4.

As illustrated by termination block 328 in FIG. 3 the shared account step-up process 300 may end when the primary user 5 has completed adding, deleting, and/or editing the preferences in the preference interface 700.

After the preferences are set by the primary user 5 the dependent user 4 can try to use the dependent user system 20 to make a purchase. For example, the dependent user 4 can enter a store and use the dependent user system 20, which in one embodiment is a smartphone. The dependent user 4 can pay for the products using a wireless connection between the smartphone and the merchant systems 8 at a store. In one embodiment the dependent user 4 may tap or bump a device on the merchant system 8 that receives and sends information from and to the smartphone. However, in some embodiments before the transaction can be processed the smartphone can check the parameters of the purchase with the preference limits that are set on the account the dependent user 4 is trying to use to make the transaction. For example, when the information, such as the store, store type, product, product type, the price, etc. is transferred from the merchant systems 8 to the dependent user system 20 the dependent user system 20 may pass the information along to the account application 17 so the purchase can be allowed or denied. In other embodiments the merchant system 8 can receive information about the dependent user 4 from the smarphone and transfer the information about the dependent user 4, store, and product to the account application 17 so the purchase can be allowed or denied.

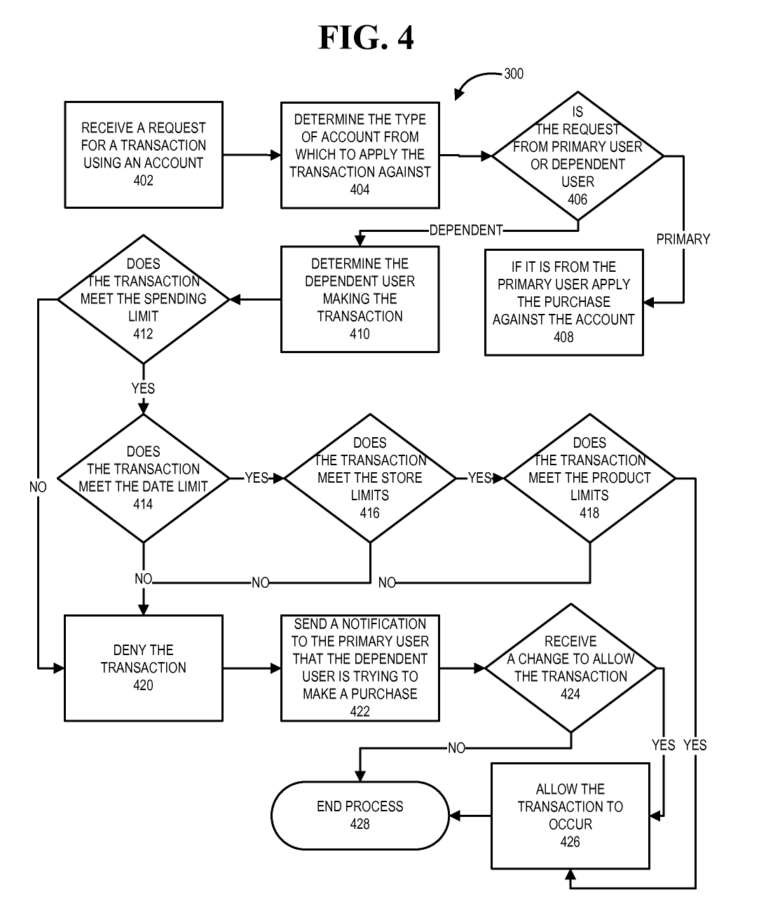

As illustrated in block 402 of FIG. 4, in one embodiment of the invention the account application 17 receives a request from a dependent user system 20, directly or through the merchant systems 8, that a dependent user 4 is trying to enter into a transaction at a store using a shared account that has associated preference restrictions. The account application 17 then determines the type of account from which the dependent user 4 is trying to make a transaction, as illustrated by block 404. As illustrated by decision block 406, the account application 17 determines if the request is from a dependent user 4 or a primary user 5. When the transaction request is from the primary user 5, as illustrated by block 408, the account application 17 applies the transaction to the shared account because the primary user 5 does not typically have any account preferences set up for purchases made by the primary user 5. When the request is from a dependent user 4, then as illustrated by block 410, the account application 17 determines the identity of the dependent user 4 because in some embodiments of the invention there are one or more dependent users 4 for each primary account.

In one embodiment of the invention the account application 17 compares the information received about the present transaction with the preferences set up for the specific dependent user 4. As illustrated by decision block 412 in FIG. 4 the account application 17 may determine if the transaction falls within the spending limit 732 set in the preferences interface 700. As illustrated by decision block 414 in FIG. 4, the account application 17 may determine if the transaction meets the date limits 734 set in the preferences interface 700. As illustrated by decision block 416, the account application 17 may determine if the transaction meets the store limits 740 set in the preferences interface 700. Furthermore, as illustrated by decision block 418, the account application 17 may determine if the transaction meets the product limits set in the preferences interface 700.

After all of the preferences are checked by the account application 17, and the transaction does not violate any preference restrictions, then the account application 17 may allow the transaction to proceed, as illustrated by block 426. In these embodiments the transaction may proceed without the dependent user 4 having to take further action. However, in other embodiments the dependent user 4 may have to take further action, such as approve the transaction, verify the purchase with the merchant systems 8, etc. For example, in some embodiments, such as when the dependent user is utilizing a smartphone to make a transaction, the dependent user 4 may have to select an accept feature on the smartphone, the dependent user 4 may have to tap or bump a device on the merchant system 8 with the smartphone, and/or the dependent user 4 may have to select an accept feature on the merchant system 8 in order to agree to the transaction.

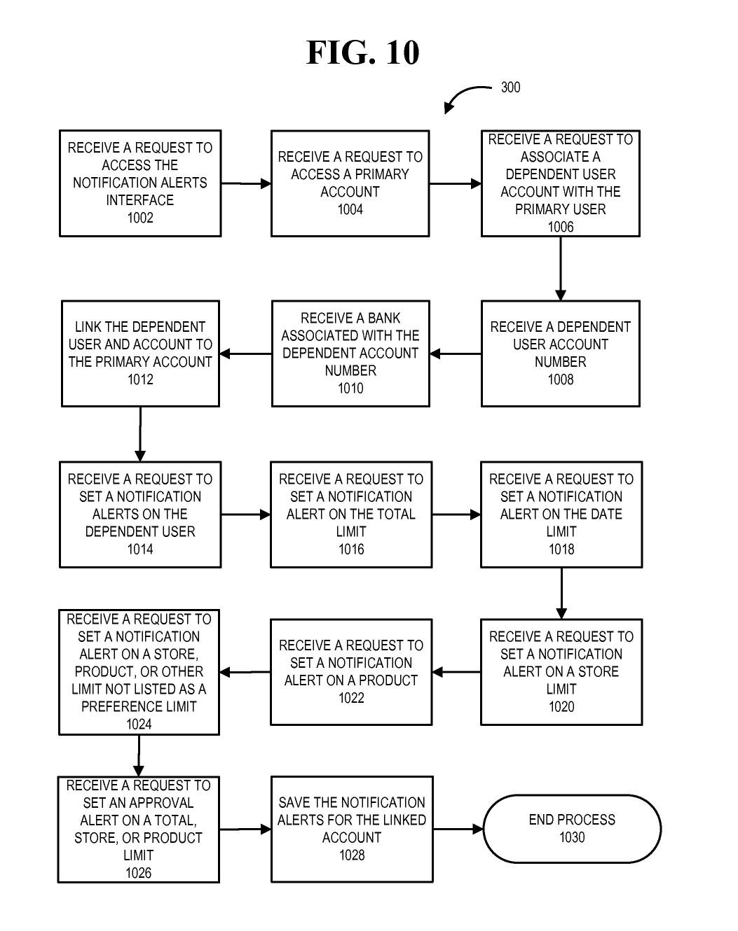

Alternatively, when one or more of the preferences are not met the account application 17 may deny the transaction as illustrated by block 420 in FIG. 4. In some embodiments the shared payment process 400 may then be terminated. However, in other embodiments the dependent user 4 may be able to send a notification alert to the primary user 5 that the dependent user 4 is trying to enter into a transaction, as illustrated by block 422 in FIG. 4. In these embodiments, the primary user 5 can decide to override on a one time basis, or otherwise change the preferences to allow the dependent user 4 to make the transaction as explained in further detail with respect to FIGS. 10 through 12. As illustrated in decision block 424 the if the account application 17 does not receive a request from the primary user 5 to allow the transaction or to change the preferences, then as illustrated by termination block 428 the shared payment process 400 may end. However, if the account application 17 receives a request to allow the transaction then the shared account application 17 may allow the transaction as illustrated in block 426. In some embodiments after the primary user 5 receives notification that that the dependent user 4 is trying to enter into a transaction that has been denied, and the primary user 5 allows the transaction to proceed, the dependent user 4 may have to take an additional step to complete the transaction as previously explained. For example, the dependent user 4 may have to make the transaction again, approved the transaction, verify the purchase with the merchant systems 8, etc.

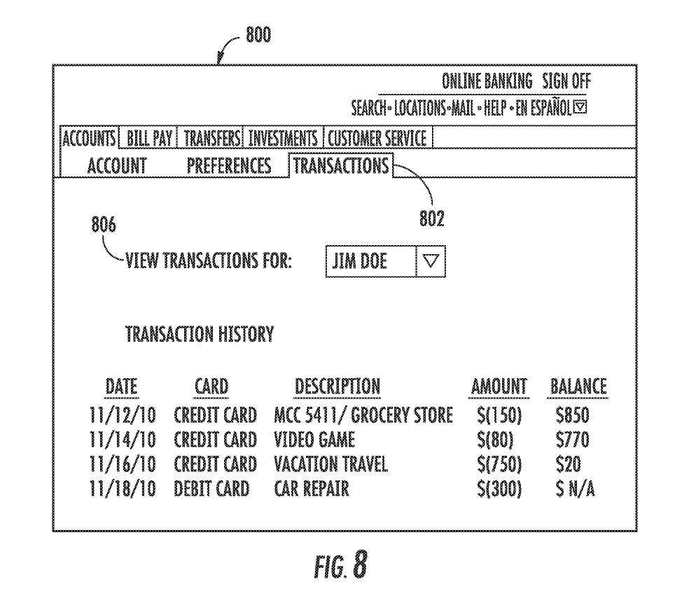

In some embodiments of the invention the primary user 5 may want to be able to review the transactions made by the dependent user 4. For example, as illustrated by the transaction interface 800 in FIG. 8, the primary user 5 may review the transactions made by a specific dependent user 4. The primary user 5 can select the transactions tab 802 in order to view the transactions. The primary user 5 may select the dependent user 4 for which the primary user 5 wants to view the transactions by navigating the drop-down menu in the view transactions section 806. The transaction history section 810, in some embodiments, displays the date 812, the card type 814, the transaction description 816, the transaction amount 818, and the balance remaining 820 based on the dependent user 4 and the preferences related to the dependent user 4. In some embodiments of the invention, the dependent users 4 can view their own transaction interface 800, in order to review the transactions that they made.

The primary user 5 or dependent user 4 can log into their online banking account to view the transactions made using the primary user system 30 or dependent user system 20. In some embodiments, the dependent user 4 has a separate online banking account, login name, and password from the primary user 5. This allows the dependent user 4 to view any transactions, but prevents the dependent user 4 from being able to make changes to the maximum credit limit or the blocked/approved MCCs, stores, or products. When the dependent user 4 tries to make a transaction that does not meet the limits set by the primary user 5 the transaction is denied and the denied transactions may also be listed in the transaction interface 800.

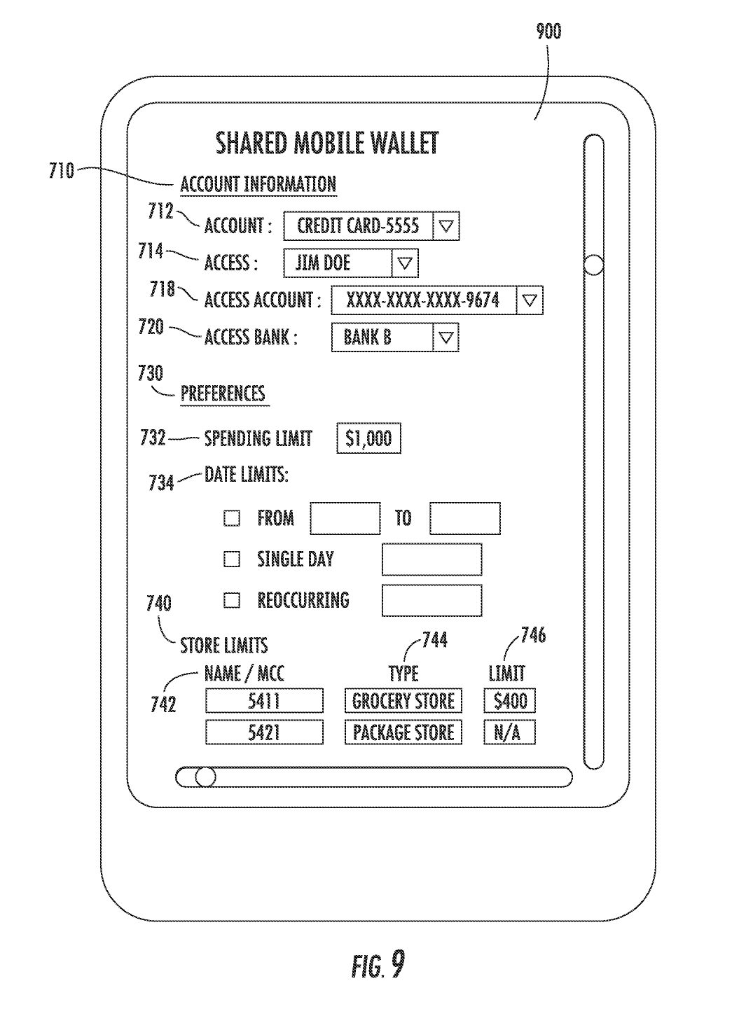

FIG. 9 displays another embodiment of the invention in which the dependent user system 20 is a smartphone or PDA. In these embodiments of the invention the primary user 5 or dependent user 5 can access the online banking application through the smartphone in order to edit the preferences (in the case of the primary user) or to view the preferences (in the case of the primary user and dependent user). However, in some embodiments of the invention the primary user 5 can access the account application 17 to set or view preferences using the primary application 27 that is downloaded directly or accessed through the smartphone, or other primary user system 20. The smartphone preferences interface 900 will look much the same as the preferences interface 700 that can be accessed through the online banking application. In this way the primary users 5 do not need to log into their online baking accounts everytime the users 4 want to view or make changes to the shared account. Furthermore, the dependent user 4 can view preferences using the dependent application 27 that is downloaded directly or accessed through the smartphone, or other dependent user system 20.

In the case where the shared account is a debit card, the settlement process would work differently than as described when the shared account is a credit card. Therefore, in some embodiments, the process may include a step wherein the shared account application 17 may also check the available balance in the debit card account or the spending limit in the credit card account (i.e., the total balance on the card not just the limit in the preference interface 700) when the transaction is made, and thus approve or deny the transaction based on whether or not the available balance or total spending limit can cover the transaction amount.

In some embodiments of the invention the preferences interface 700 can include notification alerts for each of the preferences limits set in the preferences section 730. For example, as explained in further detail below the primary user 5 can set notification amounts and notification time limits on the total limits, store limits, and/or product limits entered and/or listed in the preferences section 730 that could be the same as or less than the preference limits set in the preferences sections 730. In this way, the primary user 5 can track the transactions made by the dependent user 4 and receive notification alerts when the dependent user 4 has exceeded preference limits, is exceeding notification limits set on the preferences, and/or is making a transaction that requires the primary user's approval.

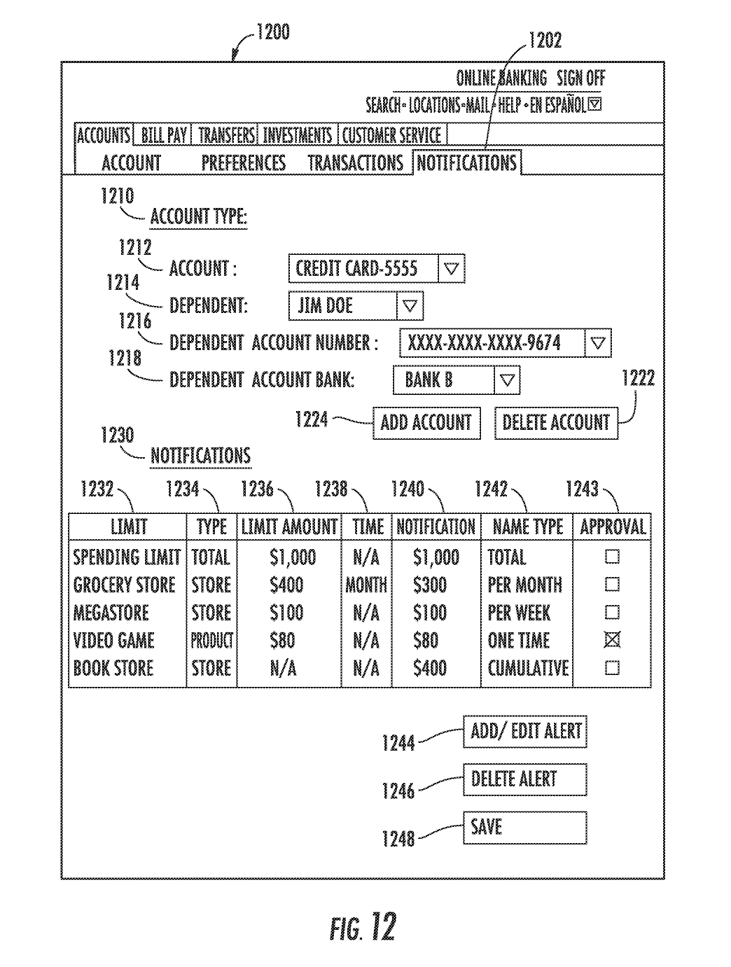

FIG. 10 illustrates a process map for a notification alert set-up process 1000, in accordance with one embodiment of the present invention. As illustrated by block 1002 in FIG. 10, the account application 17 receives a request to access the transaction notification alert interface 1200, directly through the primary user systems 30, or by accessing an online banking application, by selecting the notification tab 1202, as illustrated in FIG. 12. FIG. 12 illustrates a transaction notification alert interface 1200, in accordance with one embodiment of the present invention. The transaction notification alert interface 1200 has an account type section 1210 and a notification section 1230. As illustrated by block 1004 in FIG. 10, the account application 17 receives a request from a primary user 5 to access one of his primary accounts. In the notification tab 1202, the primary user 5 can select the shared account for which the primary user 5 wants to add a notification alert to by using the account section 1212 drop-down feature in the account type section 1220. Thereafter, the primary user 5 can select the dependent user 4 associated with the shared account for which the primary user 5 wants to add a notification limit using the dependent section 1214 drop-down feature in the account type section 1210. As explained in further detail later the primary user 5 can add notification alerts to the specific shared account.

In some embodiments of the invention the primary user 5 does not need to have a shared account with the dependent user 4, in order to set up notification alerts. In these embodiments of the invention the primary user 4 can be linked to a dependent user account. As illustrated in block 1006 in FIG. 10, the account application 17 may receive a request to associate a dependent user 4 with the primary user 5. For example, the primary user 5 can enter the name of the dependent user into the dependent name 1214 section. As illustrated in block 1008 in FIG. 10, the account application 17 may receive the dependent user account number. For example, in order to receive notification alerts related to the dependent user account, the account application 17 may need the account number of the dependent account for the dependent user 4, in order to track the purchases of the dependent user 4. The primary user 5 can enter the dependent account number in the dependent account number 1216 section in the account type section 1210.

As illustrated in block 1008 the account application 17 may also receive the bank name associated with the dependent account number 1216. In some embodiments of the invention the primary user account and dependent user account that the primary user 5 wants to link to are at the same bank. In other embodiments of the invention the primary user account and dependent user account that the primary user 5 wants to link to are at different banks. Therefore, in these embodiments the primary user 5 may also need to enter the bank at which the dependent user account is located in the dependent account bank 1218 section, in order to link to the proper account of the dependent user 4.

As illustrated by block 1012 in FIG. 10, after the primary user has entered the dependent name 1214, dependent account number 1216, and dependent bank 1218 into the account type section 1210 the primary user can select the add account button 1220 in order to link to the dependent user account.

Regardless of whether or not the primary user 5 is monitoring a dependent user's use of a shared account or monitoring the dependent user's use of his own account, the primary user can set notification alerts on either account, and in some embodiment have control over whether or not to allow the dependent user 4 to make a transaction using the account. As illustrated in block 1014, the account application 17 receives a request to set a notification alert on the dependent user 4. After the primary user 5 is linked to a dependent user account the primary user 5 can select the add/edit alert button 1244 in order to add a notification alert or edit an existing notification alert.

The primary user 5 can set a notification alert on a number of features of the dependent user account. As illustrated by block 1016, the account application 17 receives a request to set a notification alert on the total account limit. As illustrated by block 1018, the account application 17 receives a request to set a notification alert on the date limit. The account application 17, may also receive a request to set a notification alert on a store limit, as illustrated by block 1020. As illustrated by block 1022, the account application 17, may receive a request to set a notification alert on a product limit. The total limit, date limit, store limit, and/or account limit may be preferences for a shared account that have already been set by a primary user 5 and for which the primary user 5 wants to receive notification limits. In other embodiments of the invention, the total limit, date limit, store limit, and/or account limit may not be included in shared account preferences, but may be additional limits for which the primary user 5 wants to receive notification alerts. As illustrated by block 1024, the account application 17 receives a request to set a notification alert on a store, product, or other limit not listed as a preference limit, or in other embodiments that the primary user 5 wants to impose on a linked dependent account.

The primary user 5 may set the notification alerts using the transaction notification alert interface 1200 illustrated in FIG. 10. The notification section 1230, in FIG. 10, has a type name 1232 column, a type 1234 column, limit amount 1236 column, time limit 1238 column, notification amount 1240 column, notification time 1242 column, and approval 1243 column. In one embodiment, the limit 1232 column lists the name of the preferences set in the preferences interface 700. The primary user 5 can choose to set notification alerts on the preferences set in the preferences interface 700. In other embodiments of the invention the primary user 5 can add total limit notifications, store notifications, product notifications in the same or similar ways as previously described for adding preference limits in the preference interface 700. For example, the primary user 5 can enter MCCs, UPCs, store names, product names, other store identifiers, or other product identifiers in order set up the notification alerts. The type name 1232 column lists the name of total limit, store limit, and/or product limit for which the primary user wants to add a notification alert. The type 1234 may include the total limit, store limit, product limit, etc. type to distinguish total account limits from store limits and/or product limits. The limit amount 1236 column lists the preference limit set in the preferences interface 700. In other embodiments the preference limit may be set or left blank if the primary user 5 added the notification alert instead of the notification alert being automatically populated from the preferences interface 700. The time limit 1238 list any date limits set in the preferences interface 700. In other embodiments the time limit 1238 may be set or left blank if the primary user 5 added the notification alert instead of the notification alert being automatically populated from the preferences interface 700.

The primary user 5 can set the notification limit 1240 and notification time 1242 by adding the amount of the transaction and the period of time for which the primary user 5 wants to be notified of any transactions. For example, the primary user 5 may want to be notified of any transactions that occur after the dependent user 5 reaches the total spending limit of one-thousand (1000) dollars. The notification limit 1240 may also be set at a lower amount then the preference limit set in the preference interface 700. For example, the dependent user 4 may only be able to spend four-hundred (400) dollars at grocery stores per month, but a notification alert can be set to notify the primary user 5 when grocery store transactions for the month exceed the notification limit 1240 of three-hundred (300) dollars. In this way, the primary user 5 can stay aware of when the dependent user 5 is nearing the preference limit so that the primary user 5 may increase the preference limit if necessary. Notification alerts can also be set on stores or products that do not have associated preference limits. For example, the primary user 5 may set a notification limit of four-hundred (400) dollars on transactions that the dependent user 4 makes at bookstores without setting any restrictions on the transactions that the dependent user 5 can make at the bookstore. In this way the primary user 5 can monitor the transactions of the dependent user 4 without limiting the dependent user 4 from making any purchases that the dependent user 4 may need to make at the bookstore.

Returning to the notification alert set-up process 1000, as illustrated by block 1026, the account application 17 may also receive a request to set an approval alert for a preference limit on a total limit, store limit, product limit, and/or other limit. For example, as illustrated in the notification section 1230, the primary user 5 may set an approval alert on purchases of video games, by selecting the box in the approval column 1243. In some embodiments, the approval alert requires that any transaction made by the dependent user 4 needs the approval of the primary user 5 in order to be allowed. In other embodiments, the approval alert only requires the approval of the primary user 5 when a transaction is over a specific amount. In these embodiments the primary user 5 may receive a approval alert on the primary user systems 30, which requires the primary user 5 to accept or deny a transaction that the dependent user 4 is trying to make. In this way the primary user 5 has almost total control over the purchases of the dependent user 4 in that the primary user 5 can set approval alerts on any purchases that the dependent user 4 makes with the dependent user account, be it a shared account or the dependent user's own account.

The primary user 5 can add another notification limit by selecting the add/edit alert button 1244, or alternatively can delete a notification alert by selecting the delete alert button 1246. Any changes to the notification alerts can be saved by selecting the save button 1248. As illustrated by block 1028 in FIG. 10, the account application 17 receives a request to save and saves the notification alerts set on the dependent user account, be it a shared account or the dependent user's own account. As illustrated by termination block 1030 the notification alert set-up process 1000 may end after the changes made to the notification alerts are saved.

The notification alerts can come through various channels, such as but not limited to text message, e-mail, phone call, etc. through the primary user system 30 or dependent user system 20. In some embodiments of the invention, the primary user 4 and dependent user 5 may select to have specific notifications alerts be delivered through specific channels in the transaction notification interface 1200.

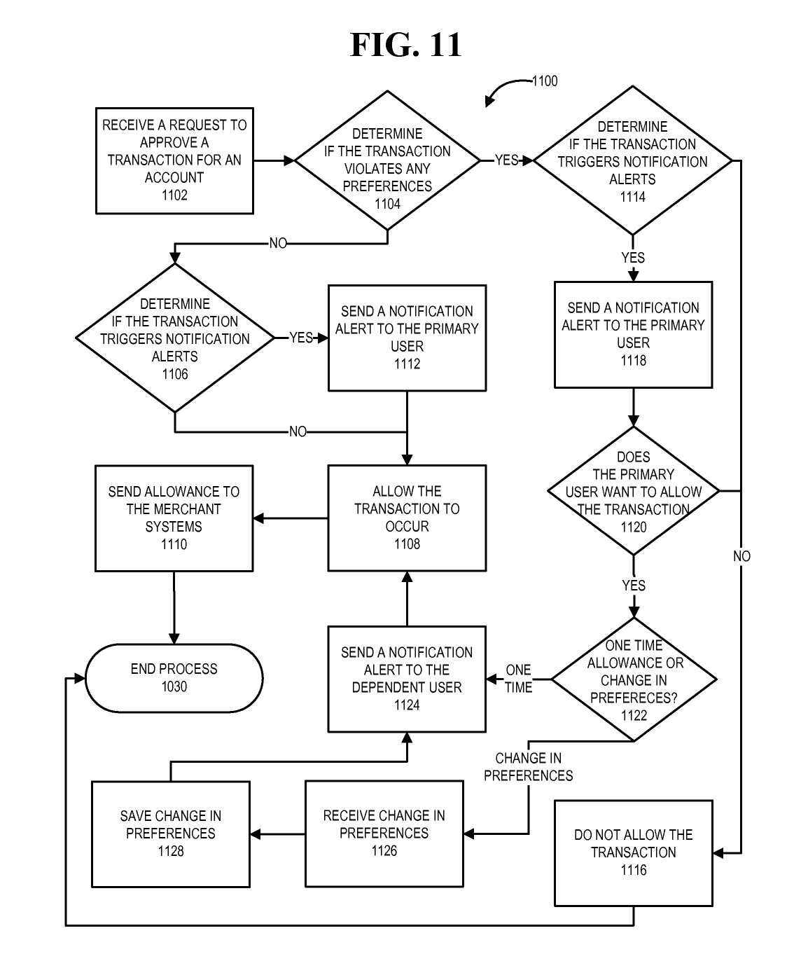

FIG. 11 illustrates a notification payment process 1100, in accordance with one embodiment of the present invention. As illustrated by block 1102 in FIG. 11, the account application 17 receives notice that a transaction for a dependent user account is taking place. In some embodiments the notice may be a notification alert or in other embodiments the notice may be a request to approve a transaction, depending on the notification limits set on the account and if the account is a shared account or the dependent user's own account. Regardless of whether the account used to make the transaction is a shared account or the dependent user's own account, the account application 17 may or may not use various steps described for the notification alert process 1100 illustrated in FIG. 11.

As illustrated by decision block 1104 the account application determines if the transaction violates any preferences. If the transaction does not violate any preferences, then as illustrated by decision block 1106 the account application determines if the transaction triggers any notification alerts. If there are no notification alerts, then as illustrated by block 1108 the transaction is allowed, and as illustrated by block 1110 the account application 17 notifies the merchant systems 8 that the transaction is approved. Thereafter, the notification alert process 1100 may end, as illustrated by termination block 1130. If however, there are notification alerts triggered, then as illustrated by block 1112 the account application 17 sends the notification alerts to the primary user 5 before, at the same time, or after the transaction is allowed. Thereafter, approval is sent to the merchant systems 8, and the notification alert process 1100 ends. As previously explained, in some embodiments, the notification alerts may simply let the primary user 5 know about the transactions that the dependent user 4 is making and not provide the primary user 4 with any control over the transactions made by the dependent user 4. However, in some embodiments the notification alerts request the primary user's approval before the transaction is allowed.

Alternatively, as illustrated by decision block 1104 if the transaction does violate preferences or requires approval, the account application determines if the transaction triggers a notification alert, as illustrated by decision block 1114. As illustrated by block 1116, if there are no notification alerts then the account application 17 does not allow the transaction to occur. Thereafter, as illustrated by termination block 1130, the notification alert process 1100 may end. However, if there are notification alerts, then as illustrated by block 1118 the account application 17 sends notification alerts to the primary user 5, on the primary user system 30. As illustrated by decision block 1120, the primary user 5 can decide to allow the transaction that violates a preference limit or requires the approval of the primary user 5, or the primary user 5 can decide to decline the transaction. As illustrated by block 1116, if the primary user decides to decline the transaction either by not responding to the merchant systems 8 with a notice of approval, or by sending the merchant systems 8 a notification that the transaction has been declined, the notification alert process 1100 may end (see block 1130).

Alternatively, if the primary user 5 does want to allow the transaction, then as illustrated by decision block 1122 the primary user 5 determines if the allowance is a one-time allowance or the primary user 5 wants to change the preference limits. If the transaction is a one-time allowance the primary user 5 selects a one-time allowance feature in the primary application 37 on the primary user systems 30, and the primary user application 37 directly, or through the account application 17, sends a notification alert to the dependent user 4 through the dependent user system 20 that the transaction has been allowed, as illustrated by block 1124. As illustrated by block 1108, the primary application 37 informs the account application 17 that the transaction is allowed, and as illustrated by block 1110 an allowance notification is sent to the merchants systems 8 to allow the transaction. As previously explained above, in some embodiments, the dependent user 4 may have to take additional action, such as but not limited to accepting the transaction allowance through the dependent user system 20 or the merchant systems 8. Thereafter, the notification alert process 1100 may end, as illustrated by termination block 1130.

As illustrated by block 1126, if the primary user 5 wants to change the preference limits or the approval notifications, the primary user 5 may access the account application 17 directly through the primary application 37 or indirectly through accessing the online banking application. The primary user 5 may then change any preference limits or approval notifications in order to allow the transaction to occur, in the same or similar way as previously explained for setting up the preference limits or notification alerts. As illustrated by block 1128, after the preference limits or approval alerts are changed they are saved by the account application 17. Thereafter, a notification alert is sent to the dependent user systems 30, to inform the dependent user 4 that the preference limits or approval alerts have been changed to allow the transaction to proceed. As illustrated by block 1108, the primary application 37 informs the account application 17 that the transaction is allowed, and as illustrated by block 1110 an allowance notification is sent to the merchants systems 8 to allow the transaction to proceed. As previously explained above, in some embodiments, the dependent user 4 may have to take additional action, such as but not limited to accepting the transaction through the dependent user system 20 and/or the merchant systems 8. Thereafter, the notification alert process 1100 may end, as illustrated by termination block 1130.

In some embodiments of the invention, instead of the primary user 5 setting notification alerts on the dependent user's account, the dependent user 4 can request notification alerts be sent to the primary user 5 automatically or on a one-time basis when the dependent user 4 has a transaction that is denied. For example, the dependent user 4 can set the notification alerts as previously explained with respect to the transaction notification alert section 1230, in the same or similar way as the primary user 5 would. In this way the dependent user 4 can send the primary user 5 notification alerts through the dependent user system 20 when the dependent user 4 exceeds or is close to exceeding preference limits. In other embodiments, on a one-time basis, the dependent user 4 may send notification alerts through the dependent user systems 20 whenever a transaction the dependent user 4 makes is denied. The dependent user can select a feature in the dependent application 27 when a transaction is denied that notifies the primary user 5 that the dependent user 4 needs access to additional funds in order to complete the transaction. In this way, the primary user 5 may approve or deny transactions that the dependent user 4 is trying to make when the primary user 5 receives the notification alerts.

The notification alert sent by the dependent user 4 can come through text message, e-mail, phone call, through the dependent application 27, etc. The primary user 5 can change the limit permanently, override the limit as a one time exception, or keep the limit the same. An override function allows the primary user to allow the dependent user 4 to make certain necessary transactions in times of need or emergency situations that ordinarily would not be allowed. This feature can be implemented through many different types of payment scenarios. For example, in some embodiments the feature could be used if the dependent user 4 is making a purchase at store checkout, in which the purchase would be denied because it violated a limit. The shared account application 17 could notify the primary user 5 before the transaction is denied, to allow the primary user 5 to override the limit as a one time exception. In other embodiments, the dependent user 4 could notify the primary user 5 through the online banking application that he wants to make a purchase that he knows will be denied in order to get approval for the transaction before the dependent user 4 tries to make the purchase. For example, the dependent user 4 could notify the primary user 5 of a purchase on a product through the dependent user system 20 and the primary user 5 could respond by allowing the transaction using the primary user system 20. Thereafter, the account application 17 would allow the one time transaction that does not meet the preferences set on the dependent user account.

The various interfaces illustrated and described herein are for example purposes and it is to be understood to one of ordinary skill in the art that other interfaces could be used in the same or similar way to accomplish setting preference limits and notification alerts on the account of a dependent user 4.

In other embodiments of the invention, the primary user and/or the dependent user can request to be notified when a particular limit is close to being reached or has been reached. For example, in some embodiments the primary user 5 or dependent user 4 can request a notification alert from the shared account when the dependent user has reached a percentage of a monetary limit, such as eighty (80) percent of the money that can be spent at grocery stores. This feature allows the primary user 5 and/or the dependent user 4 to be aware of the spending of the dependent user 4. Thus, allowing the primary user 5 to change the limits if necessary and/or allowing the dependent user 4 to control his spending or request that the primary user 5 change the preference limits. These features also allow the primary user 5 and the dependent user 4 to pay down certain limits before they reach the maximum limit in order to prevent additional transactions from being denied.

In some embodiments, the primary user 5 may want to pay off some transactions immediately or sometime before the end of the billing cycle, therefore the notification alerts allow the primary user 5 to manually pay off certain transactions made by the dependent user 4. Furthermore, in some embodiments the primary user 5 can link the shared account to another account and set up automatic payments to occur at various times for various transactions made by the dependent user 4.

In some embodiments of the invention, a reward system can be implemented for the shared account. In addition to limits set by the primary user 5, the primary user 5 may want to set spending goals that are lower than the limits in order to control the user's spending, but leave enough credit available for the dependent user 4 in case there is an emergency situation. For example, the primary user 5 may set a limit of five-hundred (500) dollars at the bookstore in case the dependent user 4 needs supplies from the bookstore, however, the primary user 5 only really wants the dependent user 4 to spend three-hundred (300) dollars. In some embodiments the primary user 5 can set a goal of three-hundred (300) dollars and a limit of five-hundred (500) dollars on the bookstore. If the dependent user 4 spends less than the goal for the specified time limit then the limit on another store or product can be removed, or increased. For example, the dependent user 4 can now spend one-hundred (100) dollars at an electronics store. Alternatively, if the dependent user 4 spends more than the goal then the limit on another store or product can be set or decreased. For example, the dependent user 4 can no longer make purchases at movie theaters, or other entertainment related stores when the dependent user 4 spends more than the goal.

In some embodiments of the invention, a primary user 5 can utilize a primary user system 20, which includes a data capture system, to set preference limits on stores directly at the store location. In one embodiment, the primary user 4 can utilize the primary user system 20, having a data capture system comprising a data capture device and a data capture application, such as but not limited to a GPS device and application, a scanning device and application, an image capture device and application, and/or a wireless transmitter device and application. For example, in one embodiment, if the primary user 5 is in a location, such as a store, restaurant, bar, etc., which the primary user 5 would like to add to the list of blocked/approved stores, the primary user 5 can use the shared payment system 20 to add the store to the blocked/approved list.

In some embodiments, the primary user 5 can log into the shared account through the online banking application or through the primary application 27 using the primary user system 20, such as but not limited to a smartphone, PDA, etc. The primary user system 20 may have a GPS device and application that can determine the location of the primary user 5. Therefore, while the primary user 5 is logged into his shared account the primary user 5 can select a function in the shared account that adds the primary user's current location to blocked/approved list. The primary application 27 may add the store automatically or it may display the location to the primary user 5 on the primary user system 20 for the primary user's approval. The account application 17 can save the store identified by the GPS to the list of blocked/approved stores.

In other embodiments, instead of using GPS to identify the store location, the primary user 5 can take an image of the store, store name, address, or other identifier, and an image capture application can use the image or data captured in the image to identify the store by cross-referencing the image or data of the store with information stored by the bank or other servers over the network 2. When the image capture application identifies the store the primary application 27 can add the store to the blocked/approved list automatically or it may display the store on the primary user system 20 for the primary user's approval. In still other embodiments of the invention the primary user 5 can use a wireless transmitter device and wireless transmitter application in the primary user system 20 to capture information about a store identifying the store by type, name, address, etc. in order to add the store to the a list of blocked/approved stores in the shared account. The wireless transmitter device can receive information about a store from a transmitter, such as but not limited to a RFID tag, located at the store. When the wireless transmitter application identifies the store the shared account application 17 can add the store to the blocked/approved list automatically or it may display the store on the primary user system 20 for the primary user's approval to add the store to the blocked/approved list of stores.

In still other embodiments of the invention the primary user 5 can scan a barcode, or other identifier, using a scanning device and scanning application in the smartphone, to identify the store location. The primary application 27 can utilize the scanned information to add the store to the list of blocked/approved stores. For example, in one embodiment, the primary user 5 can identify a product that the primary user 5 would like to add to the blocked/approved list. The primary user 5 can log into the shared account through the online banking application or primary application 27 using the primary system 20, such as but not limited to a smartphone, PDA, etc. Therefore, while the primary user 5 is logged into his shared account the primary user 5 can select a function in the shared account that adds a product to the blocked/approved list of products using a scanning device. Thereafter, the primary user 5 can use a scanning device and scanning application in the primary system 20 to capture information on the product, associated packaging, or associated marketing materials identifying the product by name, MCC, UPC, or other identifier in order to add the product to a list of blocked/approved products in the shared account. For example, in one embodiment the scanning device can be a laser scanner that captures the barcode UPC of the product and adds the product to the blocked/approved list of products. The shared payment application 27 may add the product automatically or it may display the scanned product to the primary user 5 on the primary system 20 for the primary user's approval to add it to the blocked/approved list.

In other embodiments of the invention, while the primary user 5 is logged into his shared account the primary user 5 can select a function in the shared account that adds a product to the blocked/approved list of products using an image capture device. Thereafter, the primary user 5 can use an image capture device and image capture application in the primary system 20 to capture information on the product, associated packaging, or associated marketing materials identifying the product by name, MCC, UPC, or other identifier in order to add the product to the a list of blocked/approved products in the shared account. The image capture application can use image or data obtained from the image, through character recognition software or other software, for cross-referencing with images or data of products stored by the bank or other servers over the network 2. When the image capture application identifies the product related to the image captured by the primary user 5 the primary application 27 can add the product to the blocked/approved list automatically or it may display the product on the primary system 20 for the primary user's approval to add the product to the blocked/approved list of products. In still other embodiments of the invention the primary user 5 can use a wireless transmitter device and wireless transmitter application in the smartphone to capture information on a product, associated packaging, or associated marketing materials identifying the product by name, MCC, UPC, or other identifier in order to add the product to the a list of blocked/approved products in the shared account. The wireless transmitter device can receive information about a product from a transmitter, such as but not limited to a RFID tag on or near the product. When the wireless transmitter application identifies the product the primary application 27 can add the product to the blocked/approved list automatically or it may display the product on the smartphone for the primary user's approval to add the product to the blocked/approved list of products.

In other embodiments of the invention the dependent user 4 can utilize the dependent system 20, which includes a data capture device and a data capture application, to check to see if limits have been applied by the primary user 5 on a store at which the dependent user 4 is located or on a product in which the dependent user 4 is interested. This embodiment can work in the same or similar way as described with respect to the primary user 5 setting limits on stores and products using a data capture device and data capture application. For example, the dependent user 4 can utilize a dependent system 20, having a data capture system comprising a data capture device and data capture application, such as but not limited to a GPS device and application, a scanning device and application, an image capture device and application, and/or a wireless transmitter device and application. The dependent user 4 can use the data capture device and application to capture information about a store, such as the store MCC, store type, name, address, etc. and/or information about a product, such as but not limited to UPC, product name, product type, other identifier, etc. and use the information to determine if the primary user 4 placed any limits on the store or product. In some embodiments, the dependent user 4 can log into the shared account through the online banking application or dependent application 27 using the dependent user system 20, such as but not limited to a smartphone, PDA, etc. The data capture device and application captures the information about the store and product, as previously discussed, and the account application 17 determines if the store or product is on the blocked/approved list of stores and products. Thereafter, the dependent application 27 can display to the dependent user 4 any limits on the store or product through the shared account on the dependent user system 20. In this way the dependent user 4 can check if a transaction would be allowed at the store or on the product before making an effort to purchase a product.

In some embodiments, when a transaction is being made at the checkout of a store, at a physical store location or on the dependent user system 20, the dependent application 27 can display the limits, such as the monetary limit, the time limit, etc., as the limits would be if the user were to make the transaction or not make the transaction. In this way, the dependent user 4 can determine if a transaction that the dependent user 4 wants to make is accepted or if the transaction could prevent other transactions from being made in the future because the dependent user would be too close to the preferences set by the primary user 5.

As will be appreciated by one of ordinary skill in the art in view of this disclosure, the present invention may be embodied as an apparatus (including, for example, a system, machine, device, computer program product, and/or the like), as a method (including, for example, a business process, computer-implemented process, and/or the like), or as any combination of the foregoing. Accordingly, embodiments of the present invention may take the form of an entirely software embodiment (including firmware, resident software, micro-code, etc.), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, etc.) that can direct a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. An account system, comprising:
a memory device;
a communication device; and
a processing device operatively coupled to the memory device and the communication device, wherein the processing device is configured to execute computer-readable program code to:
receive transaction information from a merchant system related to a transaction being made using an account, wherein the information is received by the merchant system from a dependent user through a dependent user system;
determine if the transaction does or does not satisfy a preference set on a dependent account; and
send a denied notification alert to a primary user through a primary user system when the transaction does not satisfy the preference.

2. The account system of claim 1, wherein the processing device is further configured to:
receive an approval notification from the primary user to allow the transaction.

3. The account system of claim 1, wherein the processing device is further configured to:
receive a request from the primary user to change the preference in order to allow the transaction.

4. The account system of claim 1, wherein the processing device is further configured to:
send an allowance notification to the merchant system to allow the transaction.

5. The account system of claim 1, wherein the processing device is further configured to:
send an accepted notification to a primary user through the primary user system when the transaction does satisfy the preference.

6. The account system of claim 1, wherein the processing device is further configured to:
receive a request from a primary user through the primary user system to add the dependent user to the shared account.

7. The account system of claim 1, wherein the processing device is further configured to:
receive a request from a primary user through the primary user system to set a preference on the use of a shared account by a dependent user.

8. The account system of claim 1, wherein the preference is a prevention limit on the transaction that limits the transaction made by the dependent user based on a monetary limit, product limit, store limit, or time period limit.

9. The account system of claim 1, wherein the preference is an allowance limit on the transaction that limits the transaction made by the dependent user based on a monetary limit, product limit, store limit, or time period limit.

10. The account system of claim 1, wherein the preference is a notification alert limit on the transaction made by the dependent user based on a monetary limit, product limit, store limit, or time period limit.

11. The account system of claim 1, wherein the preference is a store preference and is assigned using a merchant category code, a store type, or a store name.

12. The account system of claim 1, wherein the preference is a product preference and is assigned using a universal product code, a stock keeping unit, a product type, or a product name.

13. The account system of claim 1, wherein the primary user system is a shared mobile wallet.

14. The account system of claim 1, wherein the dependent user system is a shared mobile wallet.

15. The account system of claim 1, wherein the account is a credit card account.

16. The account system of claim 1, wherein the account is a debit card account.

17. The account system of claim 1, wherein the account is a gift card account.

18. The account system of claim 17 wherein the gift card account is a prepaid account funded by an account owned by the primary user.

19. A method, comprising:
receiving transaction information from a merchant system related to a transaction being made using an account, wherein the information is received by the merchant system from a dependent user through a dependent user system;
determining if the transaction does or does not satisfy a preference set on a dependent account; and
sending a denied notification alert to a primary user through a primary user system when the transaction does not satisfy the preference, through the use of a processing device.

20. The method of claim 19, further comprising:
receiving an approval notification from the primary user to allow the transaction.

21. The method of claim 19, further comprising:
receiving a request from the primary user to change the preference in order to allow the transaction.

22. The method of claim 19, further comprising:
sending an allowance notification to the merchant system to allow the transaction.

23. The method of claim 19, further comprising:
sending an accepted notification to a primary user through the primary user system when the transaction does satisfy the preference.

24. The method of claim 19, further comprising:
receiving a request from a primary user through the primary user system to add the dependent user to the shared account.

25. The method of claim 19, further comprising:
receiving a request from a primary user through the primary user system to set a preference on the use of a shared account by a dependent user.

26. The method of claim 19, wherein the preference is a prevention limit on the transaction that limits the transaction made by the dependent user based on a monetary limit, product limit, store limit, or time period limit.

27. The method of claim 19, wherein the preference is an allowance limit on the transaction that limits the transaction made by the dependent user based on a monetary limit, product limit, store limit, or time period limit.

28. The method of claim 19, wherein the preference is a notification alert limit on the transaction made by the dependent user based on a monetary limit, product limit, store limit, or time period limit.

29. The method of claim 19, wherein the preference is a store preference and is assigned using a merchant category code, a store type, or a store name.

30. The method of claim 19, wherein the preference is a product preference and is assigned using a universal product code, a stock keeping unit, a product type, or a product name.

31. The method of claim 19, wherein the primary user system is a shared mobile wallet.

32. The method of claim 19, wherein the dependent user system is a shared mobile wallet.

33. The method of claim 19, wherein the account is a credit card account.

34. The method of claim 19, wherein the account is a debit card account.

35. The method of claim 19, wherein the account is a gift card account.

36. The method of claim 35, wherein the gift card account is a prepaid account funded by an account owned by the primary user.

37. A computer program product for a system, the computer program product comprising at least one non-transitory computer-readable medium having computer-readable program code portions embodied therein, the computer-readable program code portions comprising:
an executable portion configured for receiving transaction information from a merchant system related to a transaction being made using an account, wherein the information is received by the merchant system from a dependent user through a dependent user system;
an executable portion configured for determining if the transaction does or does not satisfy a preference set on a dependent account; and
an executable portion configured for sending a denied notification alert to a primary user through a primary user system when the transaction does not satisfy the preference.

38. The computer program product of claim 37, further comprising:
an executable portion configured for receiving an approval notification from the primary user to allow the transaction.

39. The computer program product of claim 37, further comprising:
an executable portion configured for receiving a request from the primary user to change the preference in order to allow the transaction.

40. The computer program product of claim 37, further comprising:
an executable portion configured for sending an allowance notification to the merchant system to allow the transaction.

41. The computer program product of claim 37, further comprising:
an executable portion configured for sending an accepted notification to a primary user through the primary user system when the transaction does satisfy the preference.

42. The computer program product of claim 37, further comprising:
an executable portion configured for receiving a request from a primary user through the primary user system to add the dependent user to the shared account.

43. The computer program product of claim 37, further comprising:
an executable portion configured for receiving a request from a primary user through the primary user system to set a preference on the use of a shared account by a dependent user.

44. The computer program product of claim 37, wherein the preference is a prevention limit on the transaction that limits the transaction made by the dependent user based on a monetary limit, product limit, store limit, or time period limit.

45. The computer program product of claim 37, wherein the preference is an allowance limit on the transaction that limits the transaction made by the dependent user based on a monetary limit, product limit, store limit, or time period limit.

46. The computer program product of claim 37, wherein the preference is a notification alert limit on the transaction made by the dependent user based on a monetary limit, product limit, store limit, or time period limit.

47. The computer program product of claim 37, wherein the preference is a store preference and is assigned using a merchant category code, a store type, or a store name.

48. The computer program product of claim 37, wherein the preference is a product preference and is assigned using a universal product code, a stock keeping unit, a product type, or a product name.

49. The computer program product of claim 37, wherein the primary user system is a shared mobile wallet.

50. The computer program product of claim 37, wherein the dependent user system is a shared mobile wallet.

51. The computer program product of claim 37, wherein the account is a credit card account.

52. The computer program product of claim 37, wherein the account is a debit card account.

53. The computer program product of claim 37, wherein the account is a gift card account.

54. The computer program product of claim 53, wherein the gift card account is a prepaid account funded by an account owned by the primary user.
